(19) United States
(12) Patent Application Publication
(10) Pub. No.: US 2025/0183534 A1
(43) Pub. Date: Jun. 5, 2025

(54) BROADBAND AND MULTI-BAND PLANAR ANTENNA ARRAY ARCHITECTURES

(71) Applicant: The Trustees of Princeton University, Princeton, NJ (US)

(72) Inventors: Zheng Liu, Monmouth Junction, NJ (US); Kaushik Sengupta, Princeton Junction, NJ (US)

(73) Assignee: The Trustees of Princeton University, Princeton, NJ (US)

(21) Appl. No.: 18/886,714

(22) Filed: Sep. 16, 2024

Related U.S. Application Data
(60) Provisional application No. 63/538,305, filed on Sep. 14, 2023.

(51) Int. Cl. H01Q 5/20; H01Q 3/38; H01Q 9/27; H01Q 9/28

(52) U.S. Cl. CPC H01Q 5/20; H01Q 3/38; H01Q 9/27; H01Q 9/28

(57) ABSTRACT

Antenna arrays, systems and methods using an algorithm-based array synthesis approach of designing and manufacturing an antenna array with non-uniform element distribution which fundamentally enables low side lobe beamforming capability over desired broadband/multiband frequency range across large scanning angles.

### CROSS REFERENCE TO RELATED APPLICATION

This application claims the benefit of the filing date of U.S. Provisional Patent Application No. 63/538,305 filed Sep. 14, 2023, the disclosure of which is incorporated herein by reference in its entirety.

### GOVERNMENT INTEREST

This invention was made with government support under Grant No. FA9550-16-1-0566 awarded by the U.S. Air Force. The government has certain rights in the invention.

### FIELD OF THE DISCLOSURE

The present disclosure relates generally to systems and methods for implementing a multiband planar antenna array.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

To keep up with the growing demand for various new applications and services, frequency agility is expected to play a significant role in the next generation wireless systems. The wireless network must be capable of rapidly adapting to changing spectral environments to avoid interference and maintain optimal performance. This can improve effectiveness and efficiency, delivering higher data rates, lower latencies, and enhanced overall functionality.

Currently, such frequency agility is achieved through the use of multiple frequency-static front ends, which are designed as in-dependent phased arrays each operating across a different center frequency with narrow operation bandwidth. However, this approach comes with significant disadvantages, such as increased system size, higher component costs, more design complexity, and higher overall power consumption. Additionally, the resulting architecture does not scale well.

FIG. 1 graphically illustrates spatial aliasing associated with a typical uniform linear array (ULA) of antennas. Specifically, FIG. 1 depicts a two-dimensional (2D) array 110 of uniformly spaced antennas, which operate across a narrow-band range of frequencies dictated by the antenna spacing. Such arrays 110 are fundamentally incapable of operating across a wide range of frequencies extending beyond an octave without spatial aliasing (grating lobes) during beam steering, the grating lobes have identical intensity as the main lobe, making the desired beam direction “undefined” and therefore undesirable, thus making the ULA unusable for frequency agile system.

An ULA spaced at λ/2 at frequency f₀ will be equivalently spaced at A at 2 f₀, which provides to a spatial sampling frequency lower than Nyquist rate, leading to spatial aliasing and grating lobes in the array radiation pattern. One can increase the spatial sampling rate to guarantee the space is larger than λ/2 at highest frequency across the band, by reducing the element spacing to be λ/6 at f₀, (therefore λ/3 at 2f₀ and λ/2 at 3f₀). However, this tightly spaced arrays suffer from severe inter-element coupling, which directly deteriorate the element impedance matching and radiation efficiency. As can be seen in the spectral diagrams of FIG. 1, unwanted grating lobes (i.e., grating lobes having a side lobe level (SLL) above 0 dB) above octave bandwidth are present in the 2f₀ and 3f₀ examples.

### SUMMARY OF THE INVENTION

Various deficiencies in the prior art are addressed below by the disclosed systems and methods using an algorithm-based array synthesis approach of designing and manufacturing an antenna array with non-uniform element distribution which fundamentally enables low side lobe beamforming capability over desired broadband/multiband frequency range across large scanning angles; and design of a multi-band antenna with a stable pattern and beamwidth across wide frequency range.

A 2D non-uniform antenna array configured to operate at a minimum frequency according to an embodiment may comprise one or more planar sections having disposed thereat a respective beamformer RF integrated circuit (IC) and a respective plurality of broadband antennas such as dual port antenna array elements wherein a constrained location perturbation δₙ introduced to each antenna array element is subjected to 2D iterative optimization to correspondingly update the antenna array element locations until a desired broadband side lobe level (SLL) reduction of the antenna array has been achieved.

Instead of current narrow band phased array architectures, the disclosed approach provides spectrally agile array EM interfaces with multi-band operating frequency range over an octave (illustratively >3:1) bandwidth. This aims toward a demonstration of a spectrally agile phased array system over the shared/licensed/unlicensed bands. The disclosed approach provides dynamically programmable, frequency agile operation with high spectral efficiency, while simultaneously targeting 5G, V band, E band/new unlicensed 5G and W band as the proof of concept. Combination of the proposed architectures with the current existing MIMO approaches, such multi-band phased array system can potentially form the backbone of the next generation of wireless networks utilizing multiple available spaced spectra.

An antenna array configured to operate at a minimum frequency according to an embodiment comprises: a substantially planar substrate having non-uniformly distributed thereupon at respective locations a plurality of broadband antennas to form thereby a two-dimensional (2D) array of non-uniformly spaced antenna array elements; wherein the substrate location of each antenna array element is separated from the substrate location of each adjacent antenna array element by a respective distance of at least half the wavelength of the minimum frequency, the locations of the antenna array elements on the substrate being selected in accordance with a desired reduction in a broadband side lobe level (SLL) of a radio frequency (RF) transmission signal.

The antenna array element locations may be selected by: determining an initial distribution of antenna array elements upon the substantially planar antenna substrate, the antenna array elements being separated from each other by a distance of at least half the wavelength of the minimum frequency; introducing a location perturbation δₙ to each antenna array element; and using iterative optimization of the location perturbations δₙ of the antenna array elements to update the antenna array element locations until the desired broadband SLL reduction across a plurality of 2D beam steering angles of the antenna array has been achieved.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 graphically illustrates spatial aliasing associated with a typical uniform linear array (ULA) of antennas;

FIG. 2 is a high-level block diagram graphically illustrating a universal array design method configured to generate a universal array topology (nonuniform, sparse spaced) according to various design criteria;

FIG. 3A graphically illustrates, for several ultra-broadband 2D array topologies, exemplary initial conditions, optimization method, and resulting optimized array;

FIG. 3B provides a performance summary of the optimized arrays of FIG. 3A;

FIG. 4 graphically illustrates a raised power series (RPS) array distribution with different r settings;

FIG. 5 graphically illustrates broadband properties of a RPS array with different r settings;

FIG. 6 graphically illustrates 2D 9×9 RPS array performance;

FIG. 7 graphically illustrates an aperiodic tiling prototype and its broadband performance;

FIG. 8 graphically illustrates a multi-turn circular or oval array having a multiple ring configuration, and its bandwidth improvement gained by applying RPS distribution along radius direction;

FIG. 9 graphically illustrates a circular or oval array having a multiple section or slice configuration, and its bandwidth improvement gained in accordance with various embodiments;

FIG. 10 graphically illustrates a Converted Convex Optimization method according to an embodiment;

FIG. 11 graphically illustrates a 2D Converted Convex Optimization for a 2D RPS array;

FIG. 12 graphically illustrates high efficiency optimization of a Danzer array with GA algorithm using the reduced number of variables;

FIG. 13 graphically illustrates high efficiency optimization of a “pizza” array with GA optimizing within each slice for reduction of number of optimization variables;

FIG. 14 graphically illustrates calculated array performance as a function of number of array elements;

FIGS. 15A and 15B depict, respectively, a top view of a system architecture according to an embodiment, and a cross-section view of a portion of the system architecture;

FIGS. 16A, 16B, and 16C graphically illustrate simulated radiation patterns and beam steering performance of the system architecture of FIG. 15A at 37, 75, and 100 GHz respectively;

FIG. 17A illustrates details of antenna mounting and signal routing on a surface of the system architecture of FIG. 15A;

FIG. 17B graphically illustrates wideband performance of the antenna mounting and signal routing of FIG. 17A;

FIG. 18 schematically depicts an eight-channel beamforming transmitter chip suitable for use in the various embodiments;

FIG. 19 schematically depicts a transmit chain of the beamforming transmitter chip of FIG. 18 suitable for analyzing gain and linearity thereof;

FIG. 20 graphically illustrates PA-switch-antenna co-design for lower power loss across broadband frequency range;

FIG. 21 graphically illustrates SPDT switch gain versus output power;

FIG. 22 graphically illustrates SPDT switch waveform at large signal excitation;

FIG. 23A schematically depicts transformer-based classic and broadband 90° hybrid;

FIG. 23B graphically illustrates the amplitude response of the “through” and “couple” paths of the classic and broadband 90° hybrid circuitries of FIG. 23A;

FIG. 24A schematically depicts a differential quadrature phase generation network, namely a balun with classic or broadband 90° hybrid;

FIG. 24B schematically depicts the network of FIG. 23A with a 90° hybrid-based frequency extender;

FIG. 24C graphically illustrates a comparison of EM simulated phase/gain imbalance across 30-100 GHz among the three topologies of FIGS. 24A-24B;

FIG. 25A schematically depicts an ultra-wideband phase shifter with a differential quadrature phase generation network according to an embodiment;

FIG. 25B graphically illustrates broadband matching and code insensitive input impedance of a CB buffer of the network of FIG. 25A;

FIG. 25C graphically illustrates insertion loss across 30-100 GHz of the EM simulated ultra-wideband differential quadrature phase generation network of FIG. 25A;

FIG. 25D depicts an integrated circuit micrograph image of the phase shifter of FIG. 25A;

FIG. 26 schematically and graphically depicts inductive peaking to enhance high frequency gain close to Gₘₐₓ useful to understanding the various embodiments;

FIG. 27A schematically depicts a transformer-based Marchand balun design;

FIG. 27B illustrates a layout of the transformer-based Marchand balun design of FIG. 27A;

FIG. 27C-27D graphically illustrate insertion loss and phase/gain imbalance across 30-100 GHz, respectively, for transformer-based Marchand balun design of FIG. 27A;

FIG. 28A graphically illustrates measured amplitude/phase at 34, 54, 64 and 84 GHz for the ultra-wideband phase shifter schematically depicted in FIG. 25A, FIG. 28B graphically illustrates measured gain variation and rms gain error vs. frequency for the ultra-wideband phase shifter schematically depicted in FIG. 25A, and FIG. 28C graphically illustrates measured max phase error and rms phase error vs. frequency for the ultra-wideband phase shifter schematically depicted in FIG. 25A;

FIG. 29A schematically depicts a Broadband VGA;

FIG. 29B schematically depicts a T type network for peaking frequency response including a graphical illustration of this response;

FIG. 29C graphically illustrates simulated and measured gain of the VGA of FIG. 29A;

FIGS. 30A-30B schematically depict a RF active balun design, and end-to-end layout of the active balun, respectively;

FIGS. 30C-30E graphically illustrate simulated amplitude/gain imbalance, simulated input return loss, and simulated gain versus output power at different frequencies, respectively, for the RF active balun of FIG. 30A;

FIG. 31A schematically depicts a 1 to 8 ultra-wideband power dividing network with a 1 to 2 divider core implementation;

FIGS. 31B-31C graphically illustrate isolation improvement of the divider core, and the network performance, respectively;

FIG. 32 schematically depicts an exemplary IQ direct up-convert transmitter architecture;

FIG. 33 schematically depicts an IQ mixer schematic and Marchand balun combining network;

FIGS. 34A-34B depict an active mixer IQ core design with balanced and unbalanced layouts, respectively;

FIG. 34C graphically illustrates a comparison of IRR and LO rejection for the active IQ mixer core design with balanced and unbalanced layouts as respectively depicted in FIGS. 34A-34B;

FIG. 35A schematically depicts a baseband balun and IF VGA;

FIGS. 35B, 35C, and 35D graphically illustrate frequency response of the IF chain for different gain state, phase and amplitude imbalance frequency response, and performance versus input swing, respectively of the baseband balun and IF VGA of FIG. 35A;

FIG. 36A schematically depicts a frequency doubler and LO buffer;

FIG. 36B graphically illustrates simulated output LO power and 4th harmonic across frequency; and

FIG. 37 depicts a method according to an embodiment.

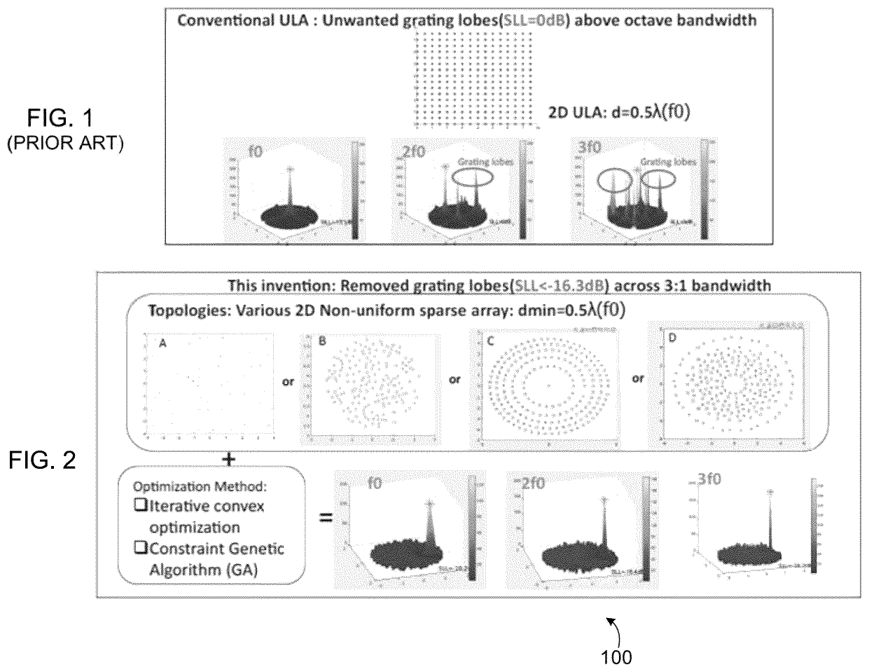

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for illustrative purposes to aid the reader in understanding the principles of the invention and the concepts contributed by the inventor(s) to furthering the art and are to be construed as being without limitation to such specifically recited examples and conditions. Additionally, the term, “or” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments, such as seismology and data fusion.

Various deficiencies in the prior art are addressed by a universal ultra-wideband phased array architecture that can operate across all the licensed/unlicensed/shared mm Wave bands (e.g., approximately 24-100 GHz), providing thereby a natural platform for integrated sensing and communication that enables simultaneous dual task with more optimal spectrum resource utilization and environmental awareness. The large bandwidth of this architecture also boosts the throughput by supporting concurrent multi-band operation where more than one band can be transmitted or received at the same time. All these benefits come with a unified single antenna array aperture and a single set of broadband circuit hardware for substantially lower cost and footprint.

Spectrum sharing is expected to be a key technology for 5G and beyond for massive enhancement in spectral efficiency and reconfigurable networks. This extends across mm-Wave licensed/unlicensed and shared spectra across 24-30 GHz, 37-50 GHz, 57-64 GHZ, 64-71 GHZ, and backhauling at the 71-76 GHz to the frequencies beyond 95 GHz. The links at these frequencies are enabled by phased or hybrid arrays exploiting beamforming necessary to close the link budget. However, in a conventional uniform linear array (ULA) system, operating over the multi-band has theoretical pattern synthesis challenges due to high grating lobes. AS such, various embodiments are specifically directed to portions or the entirety of an approximately 24-100 GHz or mmWave spectrum, which embodiments may be used to support applications in 5G/6G communications, automotive radar, satellite communications, and so on. Various embodiments are configured to support spectral regions and applications such as advanced sensing/imaging for security, industrial and defense system, environmental monitoring for internet of things (IoT), and so on.

The disclosed embodiments address these challenges by (1) an algorithm-based array synthesis approach, to generate a sparse array with non-uniform element distribution which fundamentally enables low side lobe beamforming capability over desired broadband/multiband frequency range across large scanning angles; and (2) design of a multi-band antenna with a stable pattern and beamwidth across wide frequency range.

Various embodiments provide different topologies and optimization methods of planar array element distribution, along with antenna element design to achieve ultra-broadband phased array system. Based on the disclosed methods, an antenna in package (AiP) antenna array hardware will be implemented along with fully integrated circuit front end to demonstrate wide angle beam steering capability across ultra-broadband/multi-band frequency range with reduced side lobe level performance. Compared to current narrow-band phased array system, this system disclosed herein significantly boosts the capacity and enables new frequency agile functionalities in application of wireless communication and sensing.

Various embodiments provide topologies, and methods for the design of such topologies, implementing an ultrabroadband/multiband phased array antenna. The topologies overcome the bandwidth limitations of the conventional uniform phased arrays. The general topology works both for mm-wave and RF frequencies and can be implemented either on integrated technology or PCB technology which can be a potential candidate for future broadband and frequency agile high speed mobile 5G/6G communication and sensing platform.

Various embodiments provide systems and methods using an algorithm-based array synthesis approach of designing and manufacturing a sparse array with non-uniform element distribution which fundamentally enables low side lobe beamforming capability over desired broadband/multiband frequency range across large scanning angles; and design of a multi-band antenna with a stable pattern and beamwidth across wide frequency range.

In particular, a 2D non-uniform sparse antenna array configured to operate at a minimum frequency according to an embodiment comprises a plurality of planar sections having disposed thereat a respective beamformer RF integrated circuit (IC) and a respective plurality of broadband dual port antenna array elements wherein a constrained location perturbation &n introduced to each antenna array element is subjected to 2D iterative optimization to correspondingly update the antenna array element locations until a desired broadband side lobe level (SLL) reduction of the antenna array has been achieved.

That is, instead of current narrow band phased array architectures, the disclosed approach provides spectrally agile array EM interfaces with multi-band operating frequency range over an octave (illustratively >3:1) bandwidth. This aims toward a demonstration of a spectrally agile phased array system over shared, licensed, and/or unlicensed bands. The disclosed approach provides dynamically programmable, frequency agile operation with high spectral efficiency, while simultaneously targeting 5G, V band, E band/new unlicensed 5G and W band as the proof of concept. Combination of the proposed architectures with the current existing MIMO approaches, such multi-band phased array system can potentially form the backbone of the next generation of wireless networks utilizing multiple available spaced spectra.

Various embodiments provide topologies, and methods for the design of such topologies, implementing a universal array topology (nonuniform, sparse spaced) capable of operating across multiple frequencies over more than an octave range of frequencies, overcoming simultaneously trade-offs between grating lobe issues, directivity and inter-element coupling.

FIG. 2 is a high-level block diagram graphically illustrating a universal array design method configured to generate a universal array topology (nonuniform, sparse spaced) according to various design criteria. Specifically, FIG. 2 illustrates the use of various optimized 2D array distribution to achieve grating lobe removal (acceptable side lobe levels) across ultra-broadband frequency range with wide range beam steering. As can be seen in the spectral diagrams of FIG. 2, unwanted grating lobes (i.e., SLL above 0 dB) above octave bandwidth are not present in the various examples.

Generally speaking, the various embodiments overcoming ULA bandwidth limitation by introducing a non-uniform geometry of antenna array element distribution and guaranteeing sparsity of the antenna array such that minimal distance between two elements larger than 0.51 at lowest frequency of interest.

Referring to FIG. 2, one of illustratively four candidate array types is selected 210 for use as a 2D non-uniform sparse array; namely, a raised power series (RPS) array 210A, an aperiodic tiling array 210B, a first non-transitional symmetrical array (circular or oval array in a multiple ring configuration) 210C, and a second non-transitional symmetrical array (circular or oval array in a rotational symmetry or “pizza” slice configuration) 210D. Other non-uniform antenna array element distribution geometries may also be used within the context of the various embodiments.

The spacing/location of the antennas forming the selected candidate array type is then optimized 220 in accordance with a respective optimization technique (as will be described in more detail below) to provide thereby an optimized array exhibiting a desired ultra-broadband performance.

In various embodiments, the RPS array 210A is optimized using a 2D iterative convex optimization; the aperiodic tiling inspired array is optimized using a constraint genetic algorithm (GA); the first non-transitional symmetrical array is optimized using RPS radius distribution; and the second non-transitional symmetrical array is optimized using slice-by-slice constraint GA optimization.

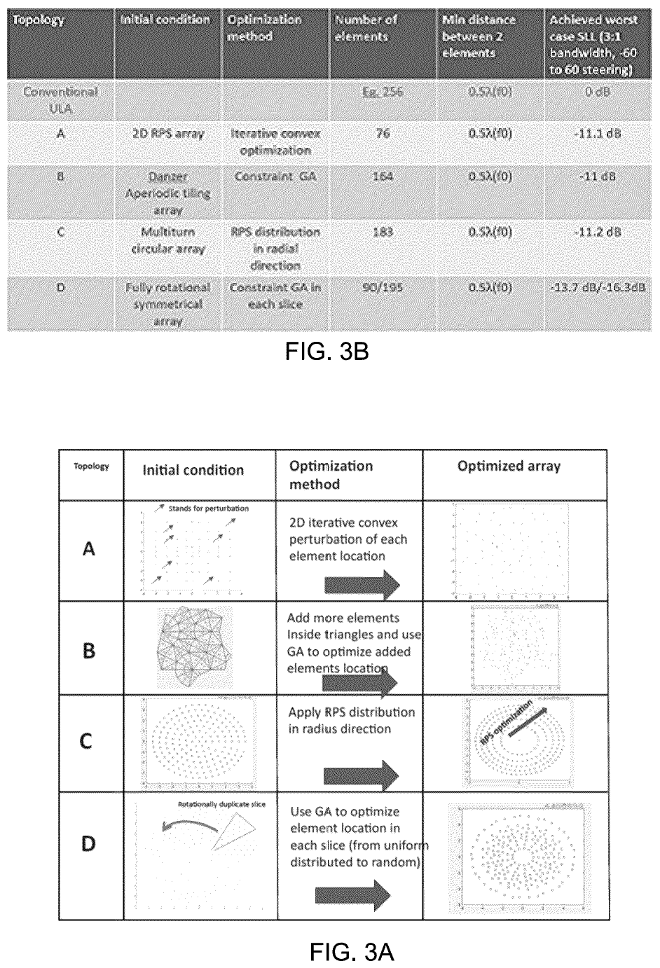

The 2D topology for the four types of arrays depicted in FIG. 2 are significantly different from a conventional 2D ULA. FIG. 3A graphically illustrates, for several ultra-broadband 2D array topologies, exemplary initial conditions, optimization method, and resulting optimized array. The performance of these four arrays in terms of worst-case side lobe level across 3:1 bandwidth across-60-to-60-degree beam steering angle is summarized in FIG. 3B. Briefly, all four designs exhibit good sparsity (minimal distance between two element is larger than λ0/2) which minimizes the coupling issue between elements compared to conventional ULA.

### 1.3.1 Problem Formulation and Definition

Consider an N-element (each element is a point source) randomly spaced 1D array with nₜₕ element location of xₙ (n=1,2 . . . . N). The total aperture size of the array is (xₙ−x₁). Define minimal spacing between two elements as dₘᵢₙ.

Each point source has a complex excitation (weight) Wₙ

$${W}_{n} = {A}_{n} {e}^{j β n} \qquad ( 1 )$$

Where Aₙ is the amplitude control and βₙ is the phase control. The array far field radiation pattern |AF| at arbitrary elevation angle θ at frequency of interest f is:

$$\vert AF ( θ , f ) \vert = \vert {\sum }_{n = 1}^{N} {A}_{n} {e}^{j ( k ( f ) {x}_{n} cos ( θ ) + {β}_{n} )} \vert \qquad ( 2 )$$

Where k(f)=2πf/C is the free space wave number, C is the light speed.

### 1.3.2 Condition of Maximum Flux at Intend Direction, Side Lobe and Optimization Goal.

From (2), for all beam coherently added (maximum radiated power) at certain angle θ₀, choose βₙ such that the argument of the exponential function is zero, so βₙ can be chosen as:

$${β}_{n} = - k ( f ) {x}_{n} cos ( {θ}_{0} ) \qquad ( 3 )$$

βₙ is determined if xₙ is known, or one can say βₙ and xₙ are dependent. Substitute (3) into (2), the array far field radiation pattern |AF| with peak power at certain steering angle of θ₀ at frequency of interest f can be written as:

$$\vert AF ( θ , f , {θ}_{0} ) \vert = \vert {\sum }_{n = 1}^{N} {A}_{n} {e}^{j ( k ( f ) {x}_{n} ( cos ( θ ) - cos ( {θ}_{0} ) ) )} \vert \qquad ( 4 )$$

At θ=θ₀, array factor and its flux achieve maximum value:

$${\vert AF ( θ , f , {θ}_{0} ) \vert}_{max}^{2} = {\vert {\sum }_{n = 1}^{N} {A}_{n} \vert}^{2} = {N}^{2} , when {A}_{n} = 1 \qquad ( 5 )$$

The second-highest peak in (5) after θ=θ₀ maximum is called peak side lobe level SLL(in dB) which is defined as:

$$SLL ( f , {θ}_{0} ) = 10 {log}_{10} ( \frac{secondhighestpeakof {\vert AF ( θ , f , {θ}_{0} ) \vert}^{2}}{max {\vert AF ( θ , f , {θ}_{0} ) \vert}^{2}} ) \qquad ( 6 )$$

Example 1: For a uniformly spaced linear antenna array with Nyquist sampled space such that xₙ₊₁−xₙ=λ/2, where λ=C/f is the wavelength of operation, and Aₙ=1, SLL(f,θ0) is independent of θ₀ and roughly −13 dB.

Example 2: For the same array when operated at 2f such that xₙ₊₁−xₙ=λ, where λ=C/2f is the wavelength of operation, and Aₙ=1, SLL(2f,θ₀) is independent of θ₀ and 0 dB. (i.e., numerical value of 1) demonstrating grating lobe formation.

Synthesis goal: Synthesis of non-uniform array with N elements with dmin≥0.5λ0 (λ₀=C/f₀), determine element positions of xₙ, and excitations Aₙe^{jβ}^{ₙ} for maximization of flux at the intended direction at θ=θ₀, where θ₀ can assume discrete values distributed between 0<θ₀<π(e.g. θ₀=0+MΔθ, where M∈ [symbol] ⁺, Δθ≈π/20), such that SLL(f, θ₀)<∈₁ and SLL(2f,θ₀)<∈₂ and SLL(Mf, θ₀)<∈_{M}, where M is the ratio between the highest frequency and lowest frequency across the broadband range, and ∥AF(θ, f, θ₀)|ₘₐₓ²−N²|<δ. The last relation eliminates a trivial solution such that A₁=1 and Aₙ=0 for n>1. To guarantee broadband performance for the frequency agile phased array application, several choices may be made including the following: M=3, ∈₁, ∈₂, ∈₃=−13 dB and δ=0.1N².

### 1.3.3 Extension to 2D Array

For an N-element 2D planer array structure in X Y plane, with location of each element to be (xₙ, yₙ), the optimization problem formulation is similar as 1D problem except the far field radiation pattern is a function of both elevation angle (θ) and azimuth angle (ϕ). For the broadside array pattern:

$$\vert AF ( θ , ϕ , f ) \vert = \vert {\sum }_{n = 1}^{N} {A}_{n} {e}^{jk ( f ) [ ( {x}_{n} sin ( θ ) cos ( ϕ ) + {y}_{n} sin ( θ ) sin ( ϕ ) ) ]} \vert \qquad ( 7 )$$

Similarly, if one wants to have all beam coherently added (maximum radiated power) at a certain angle (θ₀, ϕ₀), then AF becomes:

$$\vert AF ( θ , ϕ , f , {θ}_{0} , {ϕ}_{0} ) \vert = \vert {\sum }_{n = 1}^{N} {A}_{n} {e}^{jk ( f ) [ {x}_{n} ( U - {U}_{0} ) + {y}_{n} ( V - {V}_{0} ) ]} \vert \qquad ( 8 )$$

where U=sin (θ) cos (ϕ),U₀=sin (θ₀) cos (ϕ₀),V=sin (θ) sin (ϕ), V₀=sin (θ₀) sin (ϕ₀).

The synthesis goal is similar to that of a 1D case. For the examples and result presented in the following sections, assume the amplitude excitations for all elements are uniform, so only phase excitations are adjusted for beam steering.

### 1.4 Non-Uniform Array Geometries

From a general optimization point of view, a “brute-force” optimization starting from a random initial condition may lead to undesired result. The importance of initial conditions in optimization problems cannot be underestimated because: (1) The initial conditions can affect whether an optimization algorithm converges to a solution, and how quickly it does so; (2) The initial conditions partially determines whether an optimization algorithm converges to a local or global optimum. In some cases, starting from different initial conditions can lead to different local optima, or prevent the algorithm from finding the global optimum; and (3) The choice of initial conditions can also impact the efficiency of the optimization process. Choosing initial conditions that are closer to the optimal solution can reduce the number of iterations or computational resources needed to converge to a solution. Therefore, this section presents various nature and mathematics inspired array topologies as good initial conditions, base on which an efficient optimization of broadband array geometry can be developed.

### 1.4.1 Raised Power Series Array

Consider a 2N+1 element symmetrical 1D array xₙ, where

$${x}_{n} = \{ \begin{matrix}d \times {n}^{r} , & if n = 0 , 1 , N \\ - d \times {\vert n \vert}^{r} , & if n = - N , - N + 1 … - 1\end{matrix} \qquad ( 9 )$$

Where d is reference spacing and r is an introduced power series parameter to adjust the element spacing as n changes.

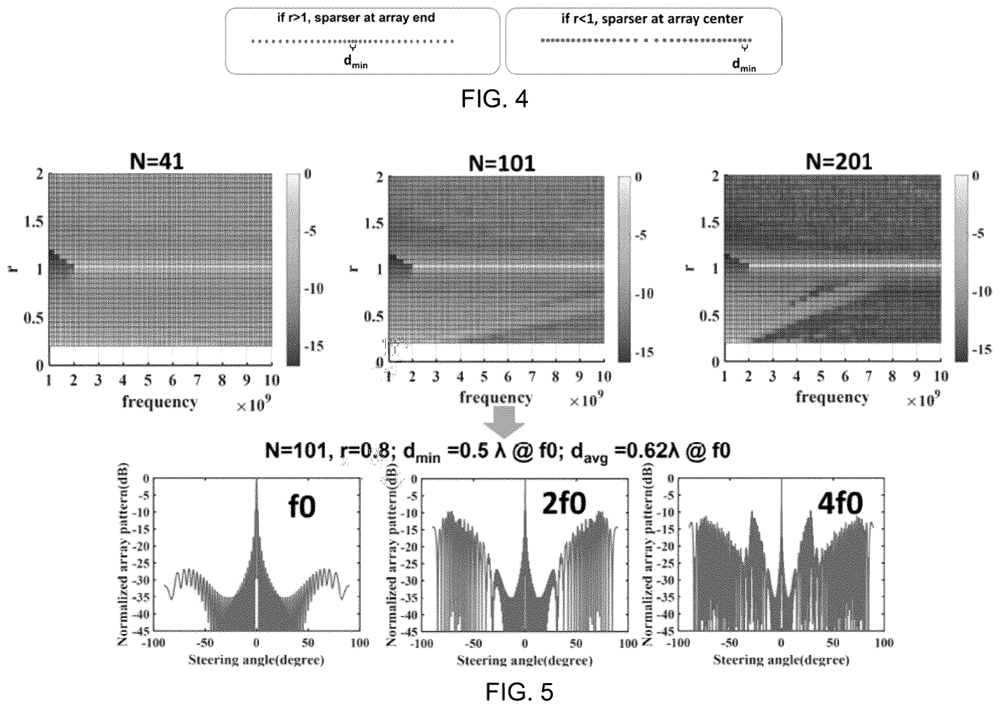

When r=1, xₙ converges to an ULA. When r≠1, xₙ becomes a raised power series (RPS) array. In particular, when r>1, the array becomes sparser at the array end while the array becomes sparser at the array center when r<1 (FIG. 4). This exponentially tapered array format provides new broadband properties, as shown in FIG. 5 wherein 2D maps exhibit the calculated SLL at broadside radiation, as a function of frequency (f₀ to 10f₀), different r values, and different number of elements, for all the calculated cases; the dₘᵢₙ is 0.5λ at f₀. The following can be concluded: 1) when r=1, as expected, the SLL jumps to 0 dB at 2f₀ frequency, which is independent of number of elements. 2) For both 0.5<r<1 and r>1 case, the SLL gets significantly improved at higher frequency, demonstrating broadband performance. r<0.5 case showing worse SLL at low frequency should be precluded in the design. 3) As number of elements increases, the overall SLL improves. The bottom part exhibits the 101-element array pattern with a choice of r=0.8 with promising worst-case SLL of −10 dB at 2f₀.

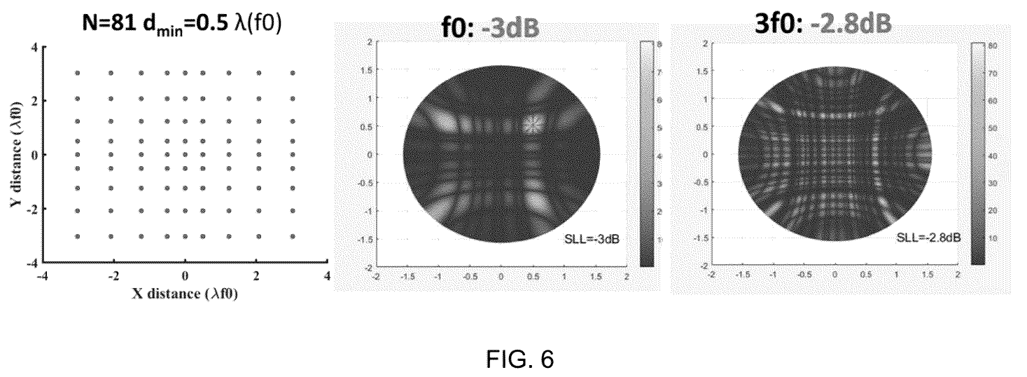

This concept is extended to a 2D array by applying the RPS distribution on both X and Y direction as shown in FIG. 6. At 3f₀, a 9×9 array has the worst-case SLL of −2.8 dB at θ of 60° beam steering angle, even though better than 2D ULA, the limited improvement is due to the small number of RPS element in both X and Y. Since RPS prototype is able to improve SLL performance only at a cost of increasing the number of elements significantly (FIG. 5), given the desired total number of elements for real application 2D array (˜100-200), the 2D RPS prototype is not able to meet the target. Therefore, a further optimization is required, which will be shown in the following session.

### 1.4.2 Aperiodic Tiling Array

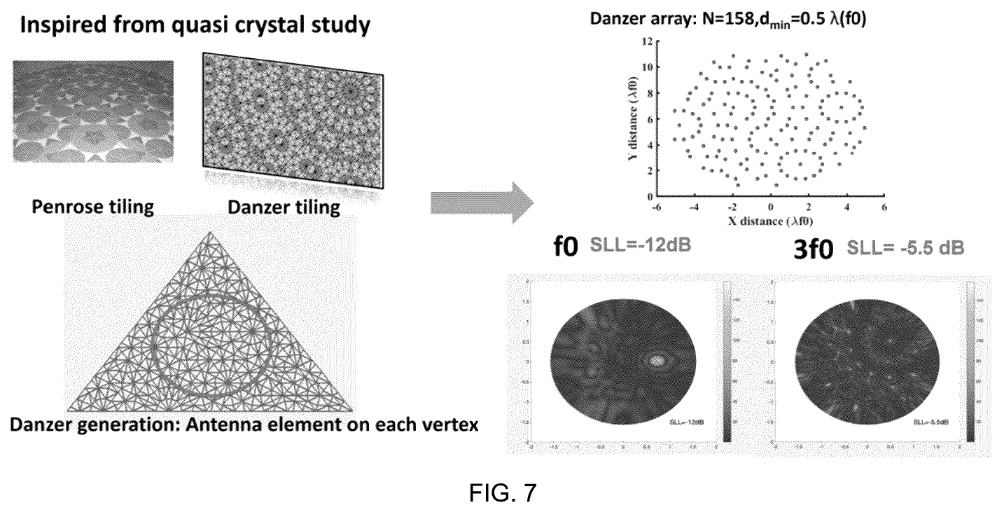

As illustrated in FIG. 7, aperiodic tilings are collections of polygons, devoid of any translational symmetries, capable of covering a plane without gaps and overlaps. This lack of regular periodicity makes aperiodic tilings useful in the design of broadband antenna arrays, if each geometry vertex is replaced by an antenna element. Aperiodic tiling arrays have been inspired by natural patterns found in various biological systems, such as quasi crystals. They exhibit a complex and seemingly random arrangement of elements that is highly efficient at achieving specific functions. Penrose and Danzer patterns, which are based on a set of mathematical rules and basic building polygons include kites, darts and various triangles, are two examples of aperiodic tilings that are investigated.

A Danzer prototype array example with N=158 and dₘᵢₙ=0.5λ(f₀) shows the worst-case SLL across beam steering angles of −5.5 dB at 3f₀, which still needs to be improved by optimization to fulfill the frequency agile array application requirement.

1.4.3 Non-Transitional Symmetrical Array-Circular Array with Uniform Radial Distribution

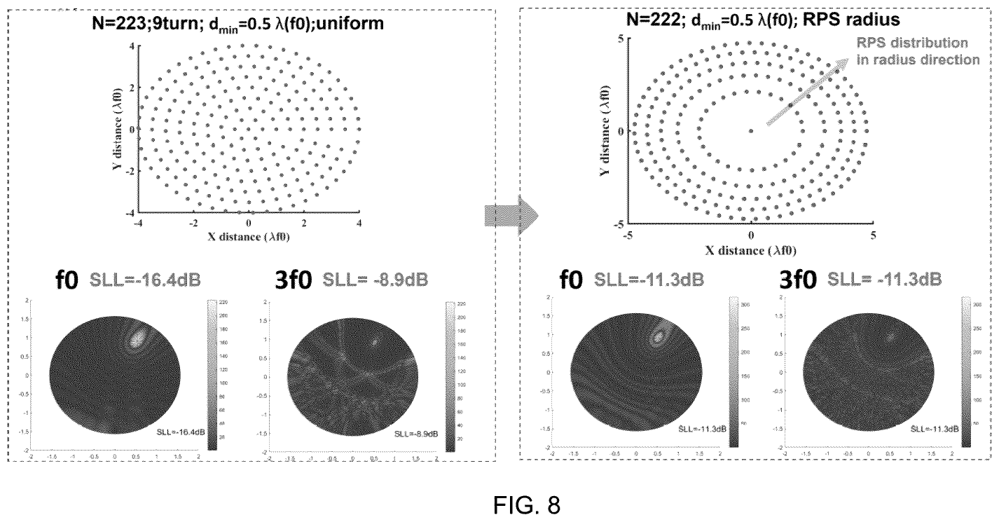

Motivated by the broadband aperiodic tiling array, which entails only rotational symmetry rather than transitional symmetry, an array with perfect rotational symmetry such as a multi-turn circular may be used. FIG. 8 graphically illustrates a multi-turn circular or oval array having a multiple ring configuration, and its bandwidth improvement gained by applying RPS distribution along radius direction. As shown in FIG. 8, an N=223, 9 turn circular array is generated with a uniform distribution along radius direction, which shows worst case SLL of −8.8 dB at 3f₀. Inspired by the RPS distribution, the bandwidth of the array can be improved by applying RPS distribution along radius direction, an N=222 array improves the worst-case SLL to be −11.3 dB at 3f₀.

1.4.4 Non-Transitional Symmetrical Array-Circular Array with Uniform Sectional Distribution

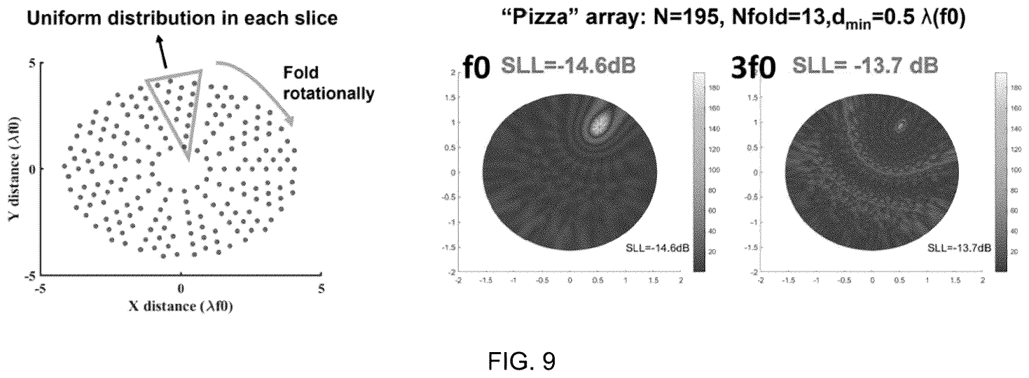

To overcome the finite RPS resolution along radius direction for potential better performance, an array with uniform radial sections or “pizza slices” may be used. FIG. 9 graphically illustrates a circular or oval array having a multiple section or slice configuration, and its bandwidth improvement gained by providing a uniform initial antenna distribution which, after optimization, is transformed into aa random optimized distribution rather than a uniform distribution. As shown in FIG. 9, each of a plurality (illustratively 6-15) of array slices are provided within which a uniform array of antenna is distributed. Forcing the rotational symmetry here by repeatedly copying a single array slice rotationally to cover the whole 2pi space, a “pizza” array is created. The apex angle of each slice is 2π/Nfold, where Nfold is the number of rotationally repeated fold and is a design parameter.

As an example, the prototype with N=195, Nfold=13 and dₘᵢₙ=0.5λ(f₀) enables worst-case SLL of −13.7 dB at 3f₀, even without any introduced optimization techniques. Table1 presents a systematic study of calculated worst-case SLL across whole 2D steering angles and f₀-3f₀ frequency range, versus different design choice of Nfold and total number of element N. Interestingly, an odd number choice of Nfold overall allows a better SLL performance especially for N=13 and N=15. The SLL improves as the number of elements in each slice increases, as shown below with respect to Table 1, which tabulates worst case SLL across θ∈(−60,60°), ϕ∈)(0,360°) and f∈(f0,3f0) versus different geometry parameters.

TABLE 1

| NFold | N | Worst case SLL (dB) |
|---|---|---|
| 9 | 261 | −10 |
| 10 | 260 | −10.1 |
| 11 | 264 | −12.6 |
| 12 | 288 | −5.6 |
| 13 | 260/195/169/117/70 | −13.2/−13.7/−12.8/11.8/−10.5 |
| 14 | 266 | −11.1 |
| 15 | 270/210/180/120/90 | −13.7/−13/−12.8/−11.8/−11.3 |
| 16 | 272 | −11.2 |
| 17 | 272 | −12.8 |

### 1.5 Optimization of Broadband Non-Uniform Sparse Array Geometry

Section 1.4 introduces multiple array topologies with considerably bandwidth improvement over conventional ULA, but they still suffer from limited SLL performance unless a large number of element (>200) is adopted, which is not affordable for the low-cost frequency agile mmWave link. Therefore, multiple effective array optimization methods will be discussed in this section, building upon the optimization goals discussed above.

### 1.5.1 Simplification of the Optimization Problem

The original synthesis flow in 3.2 is a multi-dimension optimization problem: it assumes discrete values for different beam steering direction θ₀ between 0<θ₀<π(e.g., θ₀=0+MΔθ, where M∈ [symbol] ⁺, Δθ≈π/20). For each steering angle (which means determined phase excitations), a separate optimization to minimize SLL at highest frequency needs to be performed. Obviously, such optimization is time-consuming and with high computational cost due to large number of steering angles.

To reduce the optimization problem dimension approaching fast optimization, reformulate the beam pattern equation for a desired beam direction θ₀.

$$AF ( θ , f , {θ}_{0} ) = {\sum }_{n = 1}^{N} {A}_{n} {e}^{j ( \frac{2 π f}{C} {x}_{n} ( sin ( θ ) - sin ( {θ}_{0} ) ) )} = AF ( f , U ) \qquad ( 10 )$$

where U=sin (θ)−sin (θ₀), and θ₀, is the angle referring to the normal direction of the array. If the beam steering range is θ₀∈−θₘₐₓ, θₘₐₓ), then

$$U ∈ - 1 - \vert sin ( {θ}_{max} \vert , 1 + \vert sin ( {θ}_{max} ) \vert ) = R \times Range ( sin ( θ ) ) \qquad ( 11 )$$

where Range represents the range of a function.

Here, R=1+|sin (θₘₐₓ)|. Looking at the beam pattern of the same array xₙ at broadside but with a different frequency F=f×R

$${AF}_{broadside} ( θ , R \times f , {θ}_{0} ) = {\sum }_{n = 1}^{N} {A}_{n} {e}^{j ( \frac{2 π f \times R}{C} {x}_{n} ( sin ( θ ) )} \qquad ( 12 )$$

From (11), one can see that:

$$Range ( AF ( θ , f , {θ}_{0} ) ) = Range ( {AF}_{broadside} ( θ , R \times f , {θ}_{0} ) ) \qquad ( 13 )$$

This means the initial problem of evaluating multiple steering angles may be converted to a less complex problem of evaluating a single broadside pattern, but at an equivalent higher frequency F=f×R. R is proportional to the maximum steering angles of the design, for example, 0% of 60° leads to a multiplication of frequency by 1.86.

### 1.5.2 Converted Convex Optimization

Given an initial distribution of array elements, the location of each element can be optimized for broadband SLL reduction. That is, for a 2D beam scanning in space (e.g., range of elevation angle (θ) of 30°-90° and range of azimuth angle (ϕ) from 0° to 180°), the SLL is reduced with the main beam pointing to most or substantially all angles within this space, and at most or substantially all frequencies across a frequency range of interest. This problem is highly nonlinear and non-convex. Well known algorithm such as Evolution algorithm, Particle swarm algorithm, and gradient based methods can be applied to such problem, but due to the relatively large number of element needed for the array, the number of optimization variable is typically too large (100 elements means 200 X, Y coordinate variables for the optimization) for these algorithms, along with a non-linear cost function, makes the conventional optimization methods slow and cost-ineffective.

This section introduces a method of converting the original problem to an approximate convex problem that can then be efficiently solved by leveraging the advanced convex optimization algorithm and optimizers.

Instead of optimizing the absolute location coordinate of each element xₙ, first introduce a location perturbation δₙ to each element, then the perturbed array pattern at equivalent frequency F (section 1.5.1), with Aₙ=1 is expressed as:

$${AF}_{perturb} ( θ , F , {θ}_{0} ) = {\sum }_{n = 1}^{N} {e}^{j ( \frac{2 π F}{C} ( {x}_{n} + {δ}_{n} ) ( sin ( θ ) )} \qquad ( 14 )$$

Then the optimization variables are now δₙ. Since δₙ is a small perturbation compared to absolute location, to provide thereby a Taylor expansion:

$${e}^{j ( \frac{2 π F}{C} {δ}_{n} ( sin ( θ ) )} \approx 1 + j ( \frac{2 π F}{C} {δ}_{n} ( sin ( θ ) ) \qquad ( 15 )$$

Substitute (15) to (14), the array pattern becomes:

$${AF}_{perturb} ( θ , F , {θ}_{0} ) \approx AF ( θ , F , {θ}_{0} ) + j \frac{2 π F}{C} sin ( θ ) {\sum }_{n = 1}^{N} {δ}_{n} \times {e}^{j ( \frac{2 π F}{C} {x}_{n} sin ( θ ) )} \qquad ( 16 )$$

To guarantee the equation's accuracy, the perturbation should be small enough, such as for example:

$$\vert \frac{2 π F}{C} \times {δ}_{n} \vert ≪ 1 \qquad ( 17 )$$

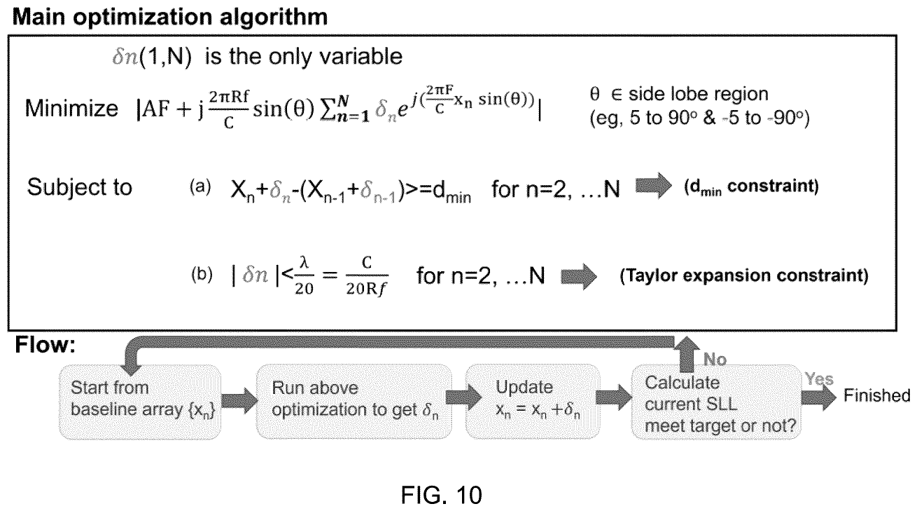

From (16), it is clearly that the optimization variable δₙ changes from an argument variable to the coefficient variable, making fast convex optimization possible. FIG. 10 graphically illustrates an algorithm flow applying multiple iterations of such iteration for a converged solution, while accounting for minimal distance (sparsity) and accuracy constraints.

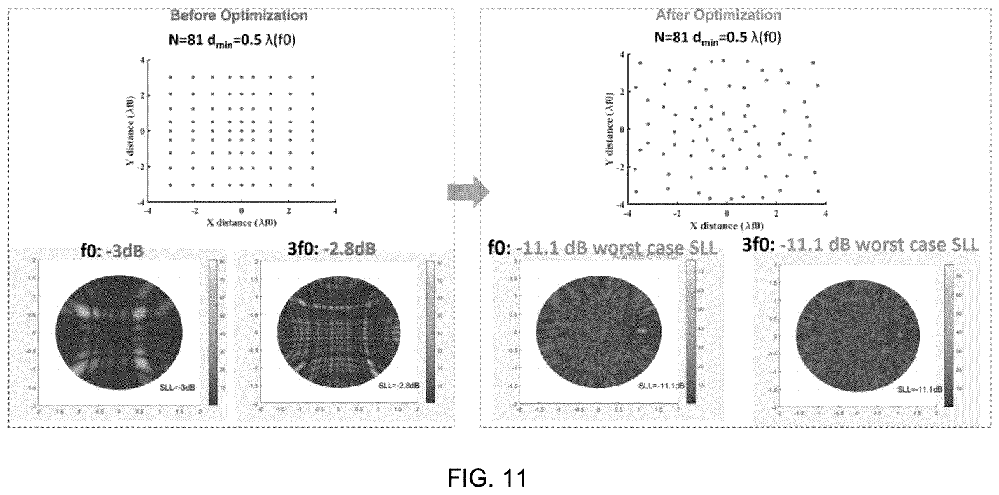

FIG. 11 graphically illustrates a 2D Converted Convex Optimization for a 2D RPS array. Specifically, it can be seen in FIG. 11 that a 9×9 2D RPS array (discussed above with respect to section 1.4.1) optimized with converted convex optimization exhibits and a significant worst-case SLL improvement of 8.2 dB, validating the effectiveness of the methods discussed herein.

1.5.3 Constraint Genetic Algorithm with Reduced Variables

Compared with brute-force optimizing numerous variables in the full phased array, a reduction of number of optimization variables leads to better optimization efficiency.

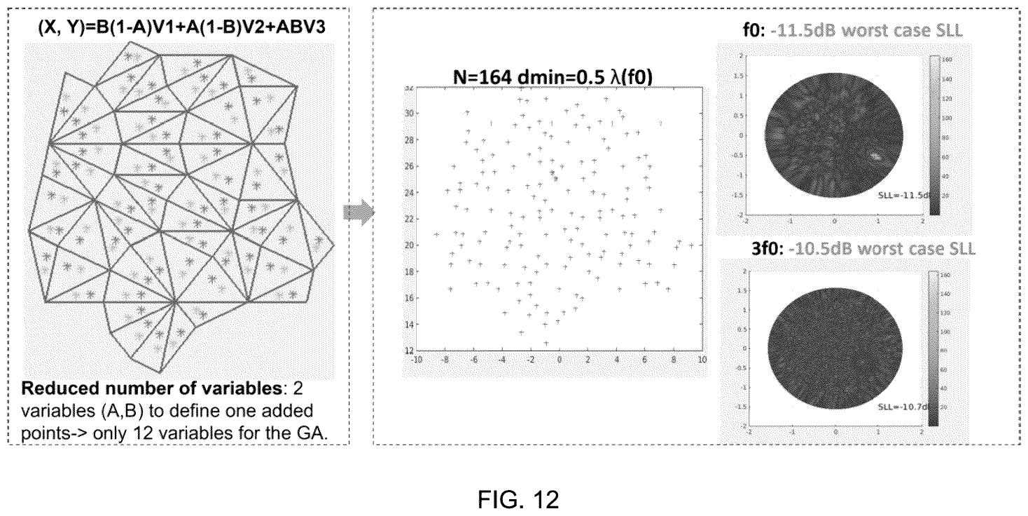

Example 1: Danzer aperiodic tiling array consists of 3 different basic building block triangles, as shown in FIG. 12, which graphically illustrates high efficiency optimization of a Danzer array with GA algorithm using the reduced number of variables. Optimization variables may be defined by adding antenna elements (2 elements in this example) within each basic triangle of the initial Danzer pattern. For each added point, two variables A and B can be used to uniquely define the position of the newly added point, given the vertex coordinate (V1, V1 and V3) of each triangle. Therefore, only 12 variables are needed for the added 6 points within 3 different triangles. Applying GA to optimize only 12 variables to efficiently synthesize a large number of elements Danzer array (N=164) while considering the constraints of 0<A<1 and 0<B<1 (guarantee that the added points are within each triangle). The array demonstrates the worst-case SLL of −11.5 dB and =−10.5 dB at f₀ and 3f₀, respectively, exhibiting considerable improvement over −5.5 dB initial case with similar number of element (see, e.g., FIG. 7 and related).

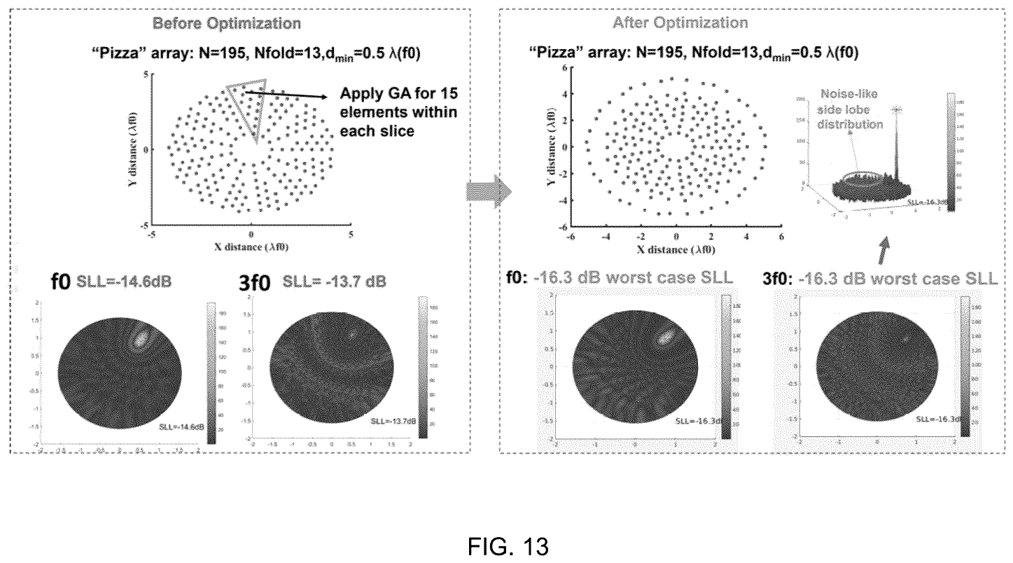

Example 2: The “Pizza” array is a candidate to apply to reduce the number of variables for GA. This is because the full array pattern can be easily calculated based on the element location of a single slices, attributed to the rotational symmetry nature of the array. As shown in FIG. 13, GA is applied to randomize and optimize only the 15 elements within each array slice under the constraint of dₘᵢₙ and angular range Δϕ<2π/Nfold. A decent array SLL of −16.3 dB (improved by 2.6 dB) the worst-case SLL over f₀-3f₀ is a manifest of the noise-like shuffled side lobe distribution, due to the essence property of non-uniformity and sparsity.

### 1.6 Summary of Optimized Broadband Array Performance

Table 2 summarizes the performance and optimization methodology of the various broadband arrays. It is noteworthy that the “broadband” does not only mean decent performance at the harmonics of the lowest frequency (f₀), but a continuous frequency range between lowest to highest frequency.

TABLE 2

| | | | | | Before | | After | |
|---|---|---|---|---|---|---|---|---|
| | | | | | optimization | | optimization | |
| | | | | Min | worst case | | worst case | |
| | | | | distance | SLL (3:1 | | SLL (3:1 | |
| | Starting | Optimization | Number of | between 2 | bandwidth, | | bandwidth, | |
| Topology | geometry | method | elements | elements | θ = −60-60°) | | θ = −60-60°) | |
| Conventional | | | E.g., 256 | 0.5λ(f0) | | | 0 | dB |
| ULA | | | | | | | | |
| BroadBand | 2D RPS | Converted | 81 | 0.5λ(f0) | −2.8 | dB | −11.1 | dB |
| array A | array | convex | | | | | | |
| | | optimization | | | | | | |
| BroadBand | Danzer | GA with | 164 | 0.5λ(f0) | −5.5 | dB | −11 | dB |
| array B | Aperiodic | reduced | | | | | | |
| | tiling | variables | | | | | | |
| BroadBand | Multiturn | RPS distribution | 183 | 0.5λ(f0) | −8.9 | dB | −11.2 | dB |
| array C | circular | in radial | | | | | | |
| | array | direction | | | | | | |
| BroadBand | “Pizza” | GA with | 90(fold 15)/ | 0.5λ(f0) | −10 dB/−13.7 dB | | −13.7 dB/−16.3 dB | |
| array D | array | reduced | 195 (fold 13) | | | | | |
| | | variables | | | | | | |
| BroadBand | Golden | Regular GA | 90 | 0.5λ(f0) | 10.7 | dB | −11.5 | dB |
| array E | spiral | | | | | | | |
| | array | | | | | | | |

### 1.6.2 Implementable Array Structure and Optimized Array Performance for Different N

For frequency agile antenna array hardware implementation, considering array performance, both 2D optimized array and “pizza” array (among others as described herein) are good candidates. However, from the perspective of system implementation difficulty, the “pizza” array may be considered more straightforward for either antenna in package or package-less RFIC-array package. This is because the rotationally repeatable fashion of “pizza” array allows a 1 to 1 mapping between a multichannel RFIC and a single array slice with a repeatable antenna feeding network, making the fabrication and assembly process much easier than the “random” distributed RPS elements, where the irregular feeding network design across the whole array is of great challenge.

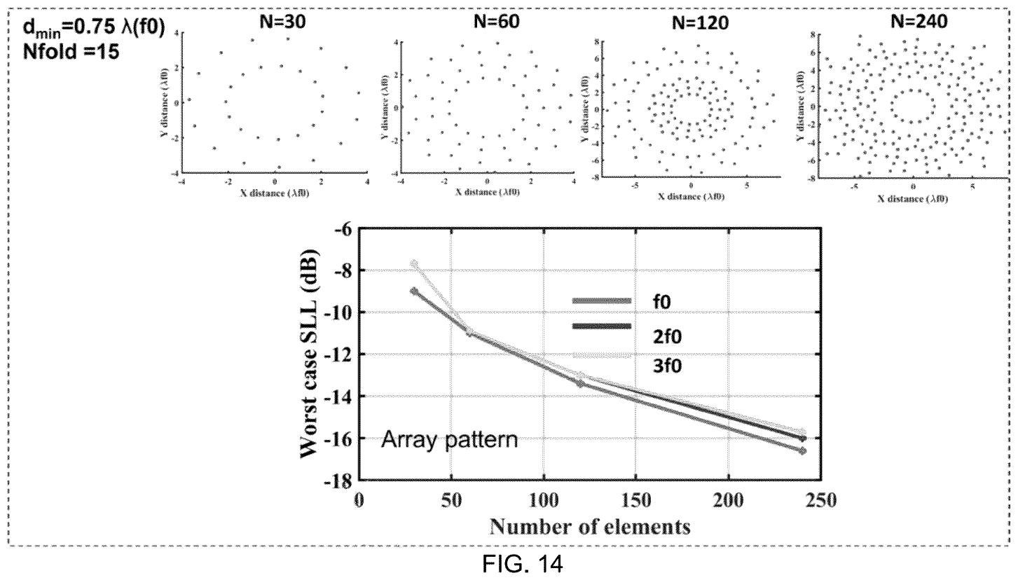

Therefore, the “pizza” array was selected for experimental implementation with Nfold=15 (which is close to 2^{N}, making global RF dividing simpler). 4 different arrays with N=30, 60, 120, and 240 are optimized separately. Considering the physical size of a real broadband antenna, which will be discussed below, dₘᵢₙ may be selected as 0.75λ(f₀) to avoid the overlap between two adjacent antennas. The calculated array performance as a function of number of array element are summarized in FIG. 14, which graphically illustrates optimized array performance for different N.

1.6.3 Optimized Array Performance for Different dₘᵢₙ

Generally speaking, a 3:1 frequency ratio has been used for real applications as discussed herein. It is noted that the performance for extremely wideband operation is also of interest for potential applications using narrow pulses as a carrier. As an example, optimized SLL performance for an N=104, Nfold=13 “pizza” array versus different dₘᵢₙ, where each dₘᵢₙ from 1.5λ to 10λ of the array is optimized separately, results in a dₘᵢₙ of 3λ manifesting a bandwidth ratio (fₘₐₓ/fₘᵢₙ) of 6:1. The array is still able to maintain SLL below −11 dB even with dₘᵢₙ of 10λ or an extremely large bandwidth ratio of 20:1.

Based on the techniques of broadband circuits and sparse array synthesis presented in the previous chapters, this chapter sheds light on the system design of a frequency agile 120-element Tx phased array covering 3:1 bandwidth.

Ultra-Broadband Transmit Array with 8×1 Beamforming IC

### 2.1 120-Element Frequency Agile Transmit Phased Array

### 2.1.1 System Architecture

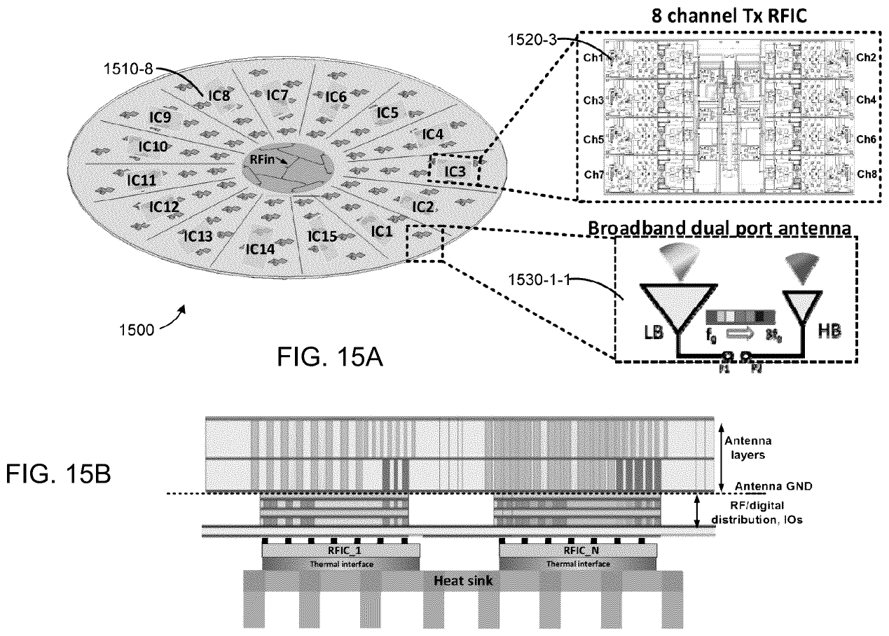

FIGS. 15A and 15B depict, respectively, a top view of a system architecture according to an embodiment, and a cross-section view of a portion of the system architecture. Referring to FIG. 15A, the depicted system architecture 1500 comprises a 120-element Tx Phased array formed as a “pizza” array with 15 folds (i.e., sections or “pizza” slices) 1510-1 through 1510-15 where each array slice “X” comprises (illustratively) eight antenna array elements formed as broadband dual port elements 1530-X-1 through 1530-X-8 and is paired with a respective 8-channel beamformer RFIC 1520-X using (illustratively) flip-chip packaging. Eight RF outputs (ch 1 through ch8) from one RFIC are routed to the eight respective antenna elements through coplanar waveguide (CPW) implemented in a high frequency package.

For each broadband radiating element 1520, its bandwidth should be evaluated in the perspective of both input matching and beamwidth of the radiation pattern. Especially for the broadband phased array, maintaining wide beamwidth (or close to isotropic pattern) is desired across the frequency range to mitigate the main-lobe reduction (or equivalent, side lobe side augmentation) due to beam steering.

The conventional ultra-broadband antenna topology such as spiral antenna can provide a large impedance matching bandwidth, but its beamwidth decreases remarkably as frequency increases due to the fixed aperture, narrowing down the beamwidth bandwidth.

Vivaldi antenna slightly moderates the above trade-offs by allowing antenna aperture to expand towards the third dimension, such antennas are typical with very high vertical profiles which restrict the capability of planar integration.

ME dipole antenna simultaneously uses an electric dipole and a magneto dipole to widen the beamwidth for both E and H plane, however, the reported bandwidth is still limited considering a reasonable antenna size.

Therefore, these single-port element topologies are deemed by the inventors to be not practically suitable for a 24-100 GHz planar array application. Rather, the inventors propose to use a dual-port antenna element wherein the entire operating frequency range is divided into a low band (LB) spectral region of approximately 32-55 GHz (˜53% fractional bandwidth) and a high band (HB) spectral region of approximately 55-100 GHz (˜58% fractional bandwidth). By using a 1-bit switching aperture according to operating frequency, the antenna beamwidth overall decreases slowly versus frequency and a wide beamwidth is maintained. In various embodiments, the HB part and LB part of the antenna may utilize a spiral antenna or bowtie antenna architecture. With this wideband structure, each antenna sub-block can cover roughly 60% fractional bandwidth without increasing size or profile, and while satisfying bandwidth needs.

Referring to FIG. 15B, the depicted cross-section view of a portion of the exemplary system architecture 1500 comprises with multi-layer high frequency high precision HDI PCB for antenna implementation, RF routing and RFIC IOs. A heat sink attaching to the backside of the RFIC chip using a thermal interface is needed for stable thermal dynamics.

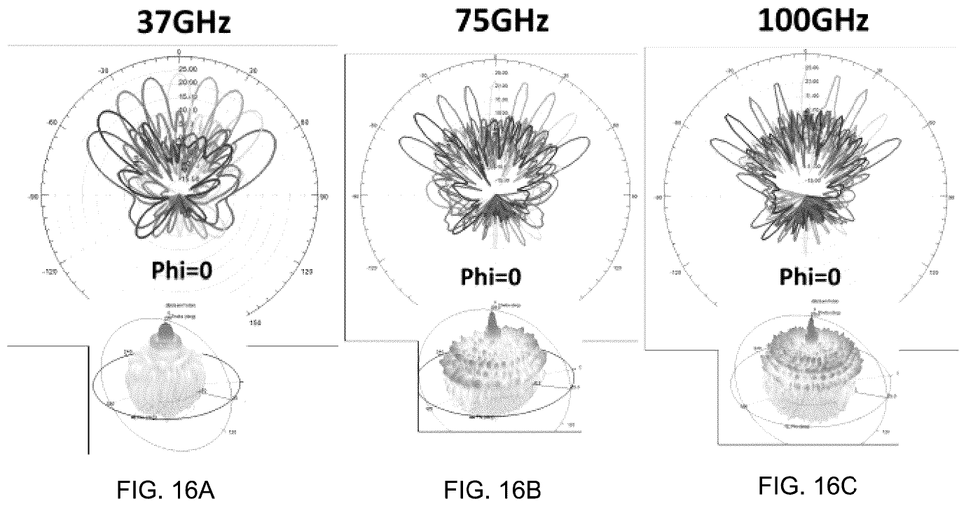

The antenna array architecture discussed herein with respect to FIGS. 15A and 15B is full-wave EM simulated, and the radiation pattern with beam-steering performances at 37, 75 and 100 GHz are demonstrated in FIGS. 16A, 16B, and 16C respectively. The low side lobe across frequency and across steering angles validates the broadband nature of the disclosed antenna architecture.

### 2.1.2 IC-Antenna RF Interface

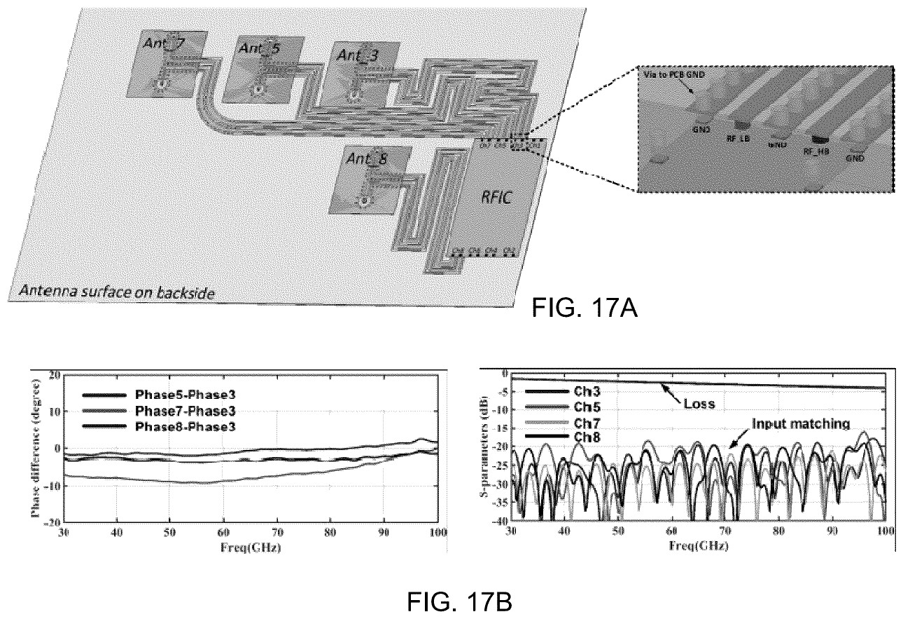

FIG. 17A illustrates details of antenna mounting and signal routing on a surface of the system architecture of FIG. 15A; namely, nonuniform physical routing from RFIC output to antenna element input on an IC-Antenna interface suitable for use in the system architecture of FIGS. 15A-15B, and FIG. 17B graphically illustrates wideband performance of the antenna mounting and signal routing of FIG. 17A. Specifically, FIG. 17A shows the RF routing between a RFIC 1520 and several non-uniformly distributed antenna elements 1530 (using 4 channels routing as an example). Due to the dual-port antenna topology, the HB-LB switch is implemented on chip with a “ground-signal-ground-signal-ground” (GSGSG) output pad allocation. For either LB or HB RF output, the RF copper pillar flip-chip bump along with two ground bumps form a CPW type transition which connects to the PCB CPW line, guaranteeing the broadband transition between RFIC and PCB. As shown in FIG. 17B, the routing to each non-uniformly located antenna is carefully addressed to keep the same electrical length, leading to very small phase difference between each channel. A less than-15 dB input reflection coefficient is achieved across 30-100 GHz for all CPW transmission lines.

### 2.1.3 8×1 Beamformer RFIC Architecture

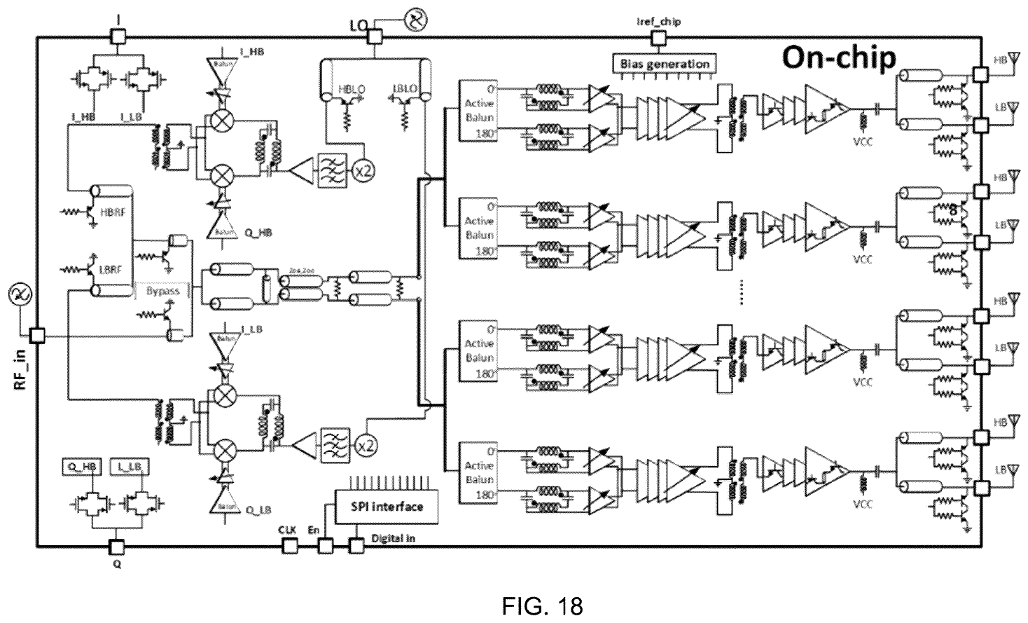

FIG. 18 schematically depicts an eight-channel beamforming transmitter chip suitable for use in a RFIC in the various embodiments. The RF beamforming architecture consists of 1) 8-channel beamformers with independent phase and amplitude control; 2) Aₙ ultra-wideband 1 to 8 RF power dividing network and 3) IQ direct up-convert transmitter for frequency conversion from baseband IQ signal pluses to RF frequency.

Each beamformer channel includes a band-select single-pole double throw (SPDT) switch connecting to the dual-port antenna, an ultra-wideband RF chain including PA, variable gain amplifier (VGA), high accuracy phase shifter (PS) and active balun for single-ended to differential conversion. The beamformer input is fed by an 8:1 ultra-wideband single-ended power dividing network with isolation enhancement between each output ports. The input of the power dividing network directly connects to the IQ up convert transmitter output, where a band select switch alternates between LB (30-55 GHZ) and HB (55-100 GHz) upconverter output ports. LB or HB IQ mixers are fed with quadrature LO generated by on-chip broadband quadrature hybrid, preceding with the LO chain. The LO chain starts from a frequency doubler with external LO signal fed between 15-50 GHz, followed by an on-chip filter for doubler harmonic filtering and a LO amplifier to enhance the LO swing. Each mixer's IF input is generated from an IF signal chain where an external IQ baseband data pulse (single-ended) firstly passes through an active balun, then fed to a differential IF VGA. 4 transmission gate switches are used to route the I and Q data input to either LB or HB upconverter IF input. The RF outputs of the two mixers are power combined using transformer based compact Marchand balun for a single-ended output. For debugging purpose, another SPDT switch is added between the IQ upconverter output and divider input such that the RF blocks (divider+beamformers) can be separated tested with an external input RF signal. The chip has a 128-bit serial peripheral interface (SPI) digital control block with a pad for external serial control bit input.

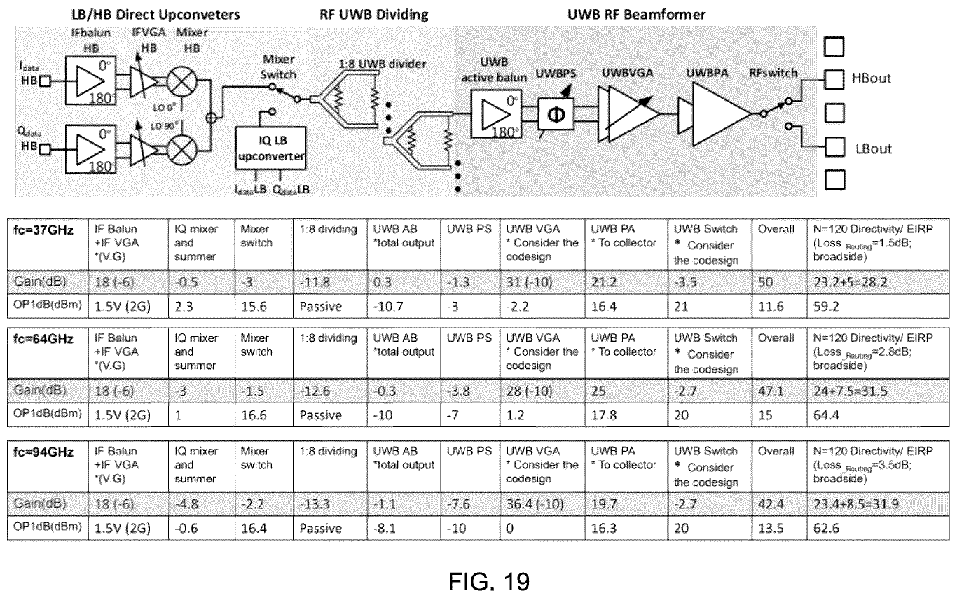

FIG. 19 schematically depicts a transmit chain of the beamforming transmitter chip of FIG. 18 suitable for analyzing gain and linearity thereof. FIG. 19 5 shows the simulated gain and OP1 dB of each Tx chain block for link analysis at widely separated frequencies, demonstrating 59.2 dBm, 64.4 dBm and 62.6 dBm Tx linear OP1 dB EIRP with N=120 element array, at 37, 64 and 94 GHz respectively. It is noted that simulated saturation output power and efficiency of a single beamformer as function of frequency demonstrates a bandwidth of 36-96 GHz over which the efficiency is >10%.

### 2.2 Broadband Beamformer Circuits Design

### 2.2.1 General Broadband Design Methodology: Interface Co-Design

Conventional multi-stage RF design are typically block based: for narrowband operation, each stage or blocks are designed for a 50Ω load and source impedance and then the different blocks can be easily cascaded. However, the 50Ω impedance assumption is not accurate for an ultra-wide band multi-stage design because it is intrinsically impossible to design matching networks for a broadband 50Ω, which means at any interface between two stages, the impedance looking back and look forward is not a 50Ω across a wide frequency range (unless using resistive matching). Therefore, a co-design method is essentially necessary for broadband cascaded blocks where one should assume the impedances at any interface are a function of frequency and the goal is to design impedance at stage interface a conjugate match at broadband frequency range, the interface impedance can be complex number and not necessarily to be 50 ohm. By doing this, a single broadband matching network can be inserted between two stages with complex frequency dependent input/output impedances, rather than using two matching networks where one is to match the previous output stage to 50Ω while the other to match the next input stage to 50Ω. A potential simpler interface matching network can lead to a lower power loss across wide frequency range while reduce the matching network area/footprint.

### 2.2.2 Ultra-Wideband Switch and PA Co-Design

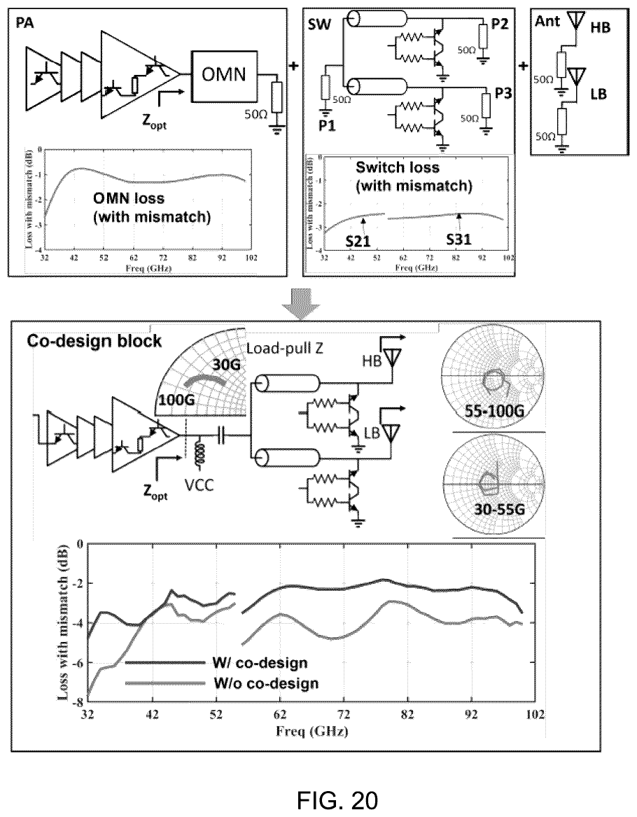

The broadband co-design method is applied for designing the PA and Band-select switch interface. As shown in FIG. 20 (upper portion), the traditional design method focuses on a broadband design of PA, switch, and antenna, assuming a 50Ω source/load impedance. The loss (with mismatch) of a broadband output matching network for the PA loadpull impedance target is shown. Similarly, the switch transducer power loss across frequency is also plotted. By directly cascading the three stages, the total transducer power loss from PA collector to antenna port is 3 to 7.8 dB from 32-100 GHz (red loss plot from bottom half the figure). This loss accounts for the mismatch loss between 1) switch and antenna interface 2) matching network output and switch input interface and 3) matching network input and PA collector interface.

On the contrary, a co-design method shown in the bottom portion of FIG. 20 aims to add a simple matching network between PA collector and switch input such that it can directly match the complex antenna input impedance to the PA load pull impedance across 30-100 GHz. In this case, only an extremely simple network of a shunt inductance and a series cap is added after the PA collector, where the original complex broadband PA matching network is removed. As a result, the total transducer power loss from PA collector to antenna port significantly improves to 2 to 4.3 dB from 32-100 GHz, an overall larger than 2 dB loss reduction than the conventional method.

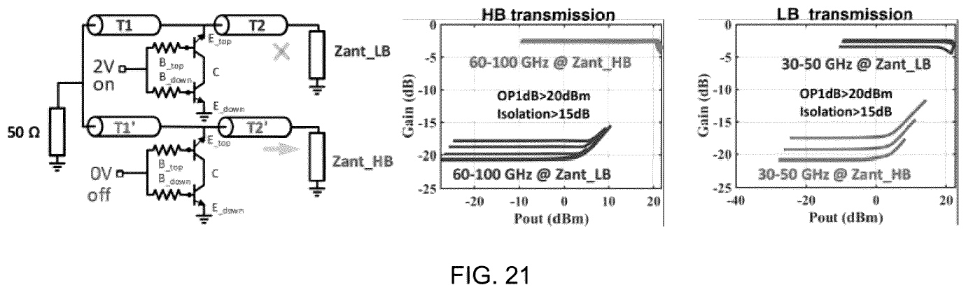

The detailed schematic of the SPDT band select switch and its large signal performance are exhibited in FIG. 21. The architecture is based on shunt switch topology where the transmission line T1/T1′ transforms the low impedance of a turn on switch to a higher impedance at the common input node, thus alternating the input signal to the other branch with the switch turned off. Due to the different load impedances for each branch (one connects to LB antenna port and one with HB port), the SPDT switch has asymmetrical parameters where T1≠T1′ and T2≠T2′, which provides more design freedom for optimality comparing to an ultra-wideband design with same load and forcing the symmetry between two paths. To guarantee enough linearity for the switch, it is proposed to use a stacked switch topology to alleviate the stress of each transistor and push the voltage that turns on and off transistor to a higher value. In addition, a reverse saturated HBT connection can reduce the parasitic capacitance between RF node to ground for lower loss. Due to the higher potential barrier between emitter-base junction than between collector-base junction, connecting the emitter to the RF node leads to a higher threshold voltage swing that turns on the emitter-base junction, leading to superior linearity. Motivated by this, the emitter of the top transistor in the stack is connected to the RF node, forming an E-B-C-B-E switch topology. The simulated gain versus output power curves demonstrates >20 dBm OP1 dB and >15 dB isolation across 30-100 GHz. The isolation is defined as the ratio of power delivered to the desired port to the power delivered to the other port. The high OP1 dB of the switch enables the high linearity of the whole Tx chain.

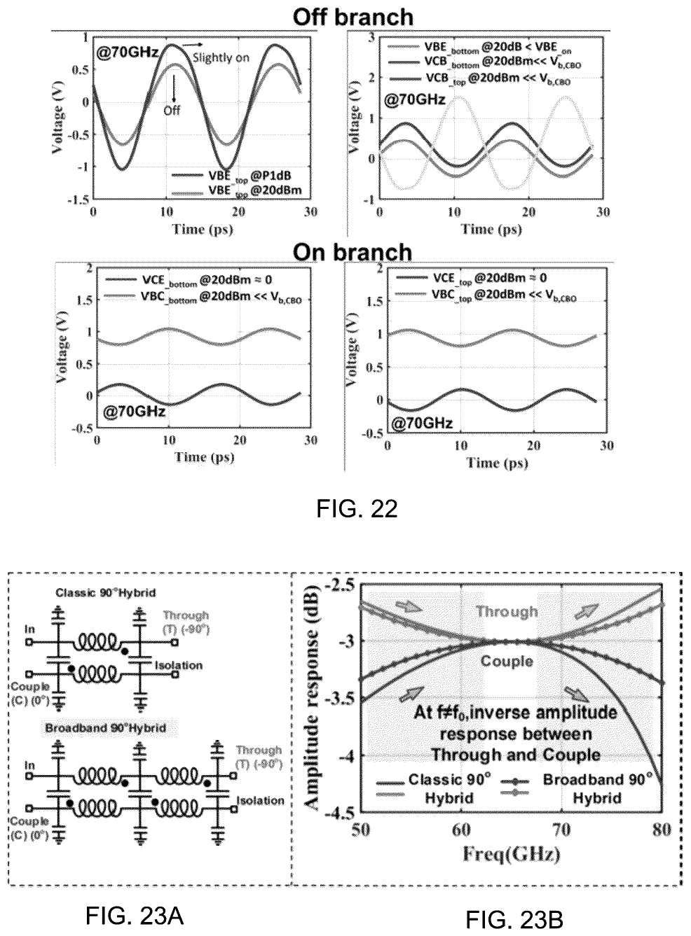

FIG. 22 graphically illustrates SPDT switch waveform at large signal excitation. Specifically, FIG. 22 shows the voltage waveform across the stacked switch under large signal output power (20 dBm) at 70 GHz. For the off branch, the key voltage to observe is the VBE of the top and bottom device where it can be seen that the swing (0.5 V) is well below the transistor VBE turn on voltage, demonstrating the linear behavior. As a comparison, when the output power reach P1 dB (21.8 dBm), the VBE swing of the top transistor increases which means the slight turn on of the top switch, reducing the transmission gain. The VCB of both top and bottom devices are far below the VB_{cbo} breakdown voltage at 20 dBm output power, guaranteeing the robustness of the switch at high power condition. For the on branch, VBC voltage swing is within the safe region for both transistors while the close to zero swing of VCE verifies the turn on operation of the switch.

The last stage of PA is based on a common-base stack topology while the first three stage are with single common-base transistor, coupled with transmission line based broadband matching networks. The PA delivers 16.4/17.8/16.3 OP1 dB and 21.2/25/19.7 dB gain at 37/64/94 GHz respectively.

2.2.3 Ultra-Wideband Phase Shifter with Quadrature Phase Bandwidth Extension Network

Achieving gain independent high accuracy phase control across broadband (>3:1 bandwidth) poses strong challenges on phase shifters design. Recent progress in broadband mm Wave phase shifters above 24 GHz utilizes RF switches to demonstrate “reconfigurable multi-band” on either passive or active phase shifter core, suffering from limited phase control range and high RF switch loss. All “RF switch-less” broadband vector IQ modulator phase shifter using Quadrature All pass Filter (QAF) broadband quadrature phase generation has been explored, but the network is very sensitive to the load (e.g., transistor gate capacitance) which significantly degrades the bandwidth. Inductive loading and de-Q techniques mitigate the issue, but the intrinsic loss due to resistance components in QAF is typically high (>10 dB loss). Moreover, the code-dependent input impedance of the active stage exacerbates the loading effect of QAF

To enable a broadband IQ vector modulator across 30-88 GHZ, use a 90° hybrid and Marchand balun-based network for wideband single-ended to differential quadrature phase generation with accurate phase/amplitude response. For the IQ VGAs and analog adder, a differential Common-base (CB) buffer stage allows ideal broadband and code independent impedance loading to the quadrature phase generation network. 5-bit accuracy with maximum phase error smaller than half LSB is demonstrated across 98.3% bandwidth up to W band.

For broadband quadrature phase generation, a compact transformer-based classic quadrature hybrid (FIG. 23A) can enable a 0.1° phase imbalance fractional bandwidth of 23% while a broadband quadrature hybrid in (FIG. 23A) enhances the phase imbalance bandwidth to 90.5%. However, the amplitude imbalance bandwidth for both hybrids still limits the bandwidth of a quadrature phase generation network. FIG. 23B graphically illustrates the amplitude response of the “through” and “couple” paths of the classic and broadband 90° hybrid circuitries of FIG. 23A;

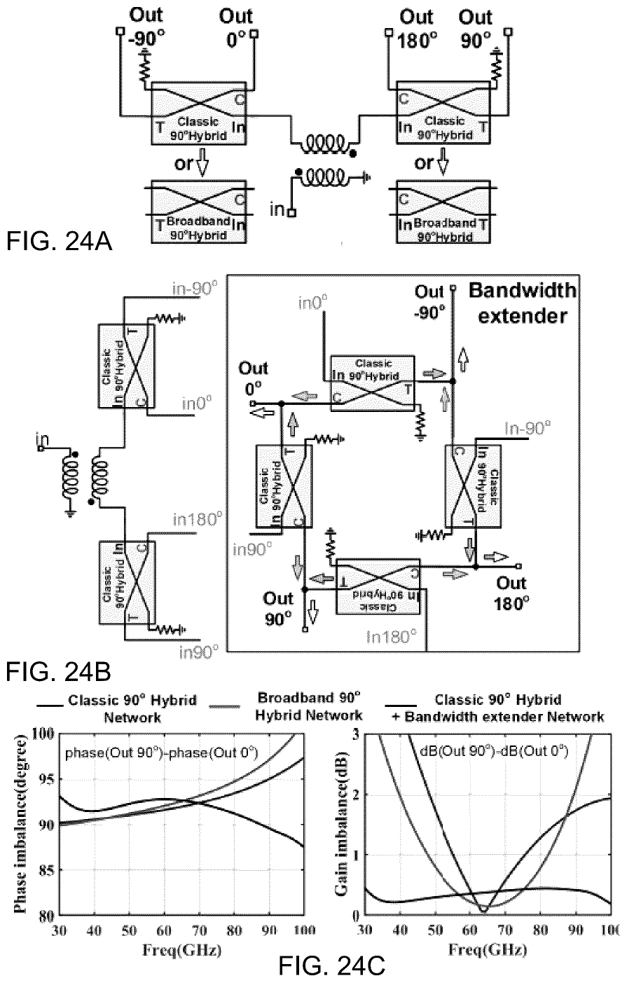

Specifically, FIG. 23B shows the amplitude versus frequency response of the ‘through’ and ‘couple’ path of both hybrids where a better amplitude imbalance can be seen for broadband hybrid, but a 0.5 dB amplitude imbalance bandwidth around 40% still cannot fulfill the need of ultra-wideband phase shifter application. A key observation is that the ‘through’ and ‘couple’ port has an inverse amplitude response away from the center frequency. To generate two differential quadrature phase signals feeding differential I/Q VGAs, a balun is used to feed its balanced output to two 90° hybrids (either classic or broadband) (FIG. 24A). In this work, the two differential outputs of this network are fed to a bandwidth extender, shown in FIG. 24B. The bandwidth extender generates each output by combining two signals generated by ‘through’ and ‘couple’ path respectively. As an example, the 0o output can be generated by combining 1) the coupled output of a 0o input signal and 2) the ‘through’ output of a 90° input signal. Utilizing the property of the inverse amplitude response between ‘through’ and ‘couple’ paths, the gain compensation across frequency results in a more broadband amplitude response. FIG. 24C compares the electromagnetically (EM) simulated phase and gain imbalance across frequency among the three networks, exhibiting a significant gain imbalance improvement using the bandwidth extender network(<0.5 dB across 30-100 GHz). The bandwidth extender consists of four compact transformer-based classic quadrature hybrids; therefore, the whole network is relatively simple to build based on a single unit block. The EM simulated insertion loss of the whole quadrature generation network(without Marchand balun) is 2.4-3.1 dB across 30-100 GHz.

The conventional Gilbert cell VGAs has a three-stack architecture which limits the headroom or power. More importantly, the gain control is done by varying the transistor bias current which causes parasitic capacitance variation, therefore the change of input impedance. Variations in the input impedance affect the quadrature generator network, resulting in additional gain and phase error. To reduce this effect, various embodiments implement a CB buffer embedded with phase quadrant control as the interface between quadrature generation and active VGA core.

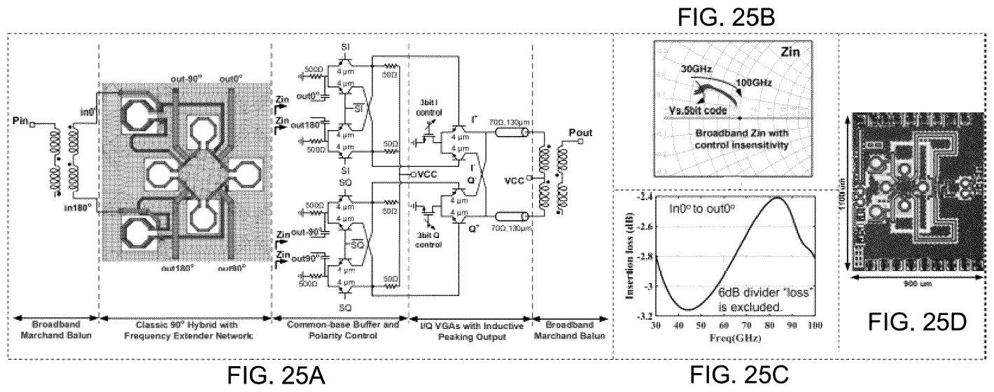

FIG. 25A schematically depicts an ultra-wideband phase shifter with a differential quadrature phase generation network according to an embodiment. FIG. 25B graphically illustrates broadband matching and code insensitive input impedance of a CB buffer of the network of FIG. 25A. FIG. 25C graphically illustrates insertion loss across 30-100 GHz of the EM simulated ultra-wideband differential quadrature phase generation network of FIG. 25A. FIG. 25D depicts an integrated circuit micrograph image of the phase shifter of FIG. 25A.

As shown in FIG. 25A, the four outputs from the quadrature generation network are fed to the emitter of the CB transistor for broadband matching. At the same time, the differential I/Q buffers allow the polarity change of the I/Q signals by controlling the base voltage of the CB transistors. Each output from the quadrature network always sees one on-transistor and off-transistor across different polarity control, therefore offering a broadband code-independent input impedance Zin (FIG. 25B). The output of the buffer is followed by I/Q differential VGAs and analog adder with 3-bit bias current control. Along with 2-bit polarity control in the first buffer stage, the phase shifter can work across all four quadrants with 5-bit control.

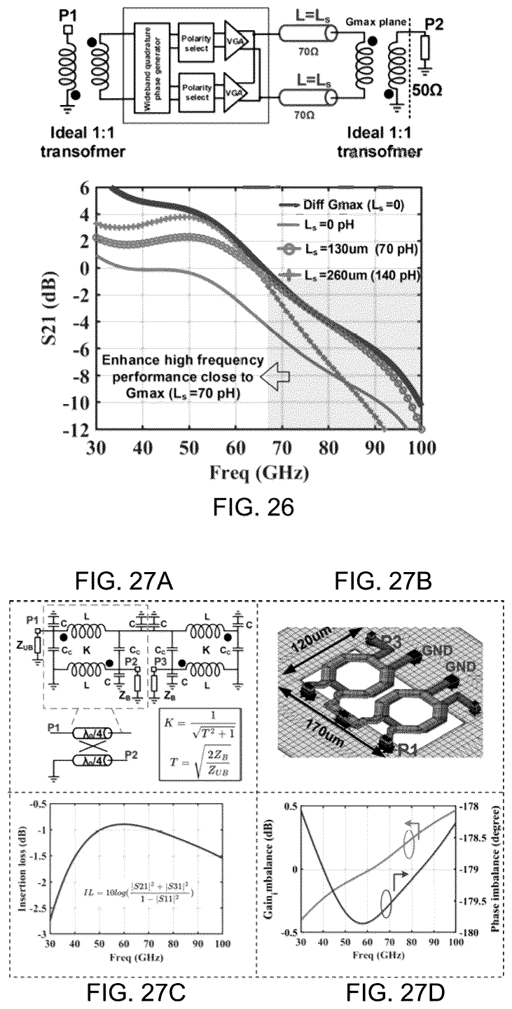

FIG. 26 schematically and graphically depicts inductive peaking to enhance high frequency gain close to Gₘₐₓ. Specifically, FIG. 26 describes the inductive peaking technique at the output of the IQ VGAs, for bandwidth broadening across 30-100 GHz. First extract the fully differential Gₘₐₓ (top curve) of the phase shifter and a proper series high impedance Transmission line (130 μm Length) is added to enhance high frequency (>70 GHz) gain by 4 dB and to be close to Gₘₐₓ. The simulated differential gain of the phase shifter is about −6 to 4 dB across 30-88 GHz and the gain slope can be compensated by another high pass amplifier in the design of the full beamformer chain.

The phase shifter operates fully differential in the beamformer chain, but on-chip single-ended to differential conversion needs to be designed for evaluation performance. A Transformer-based broadband Marchand balun is contemplated as described herein. The layout is based on the lumped modeling shown in FIG. 27A where coupling factor K determines the balun impedance transformation ratio. The compact layout, insertion loss and balancing metrics are summarized in FIGS. 27B-27D. Lower than 0.5 dB gain imbalance and lower than 2° phase imbalance over 30-100 GHz are exhibited.

The prototype is implemented in 90 nm SiGe, and an image of the implemented IC is depicted in FIG. 25D. It consumes 24 mW power under 2V supply. The phase/amplitude response is measured using Anritsu M4647B VNA with a frequency extender up to 110 GHz. Even though the ultra-wideband quadrature generation network allows a frequency-independent code setting, a post-silicon frequency-dependent code optimization which can correct the potential quadrature phase mismatch due to process variation, allows a further performance improvement.

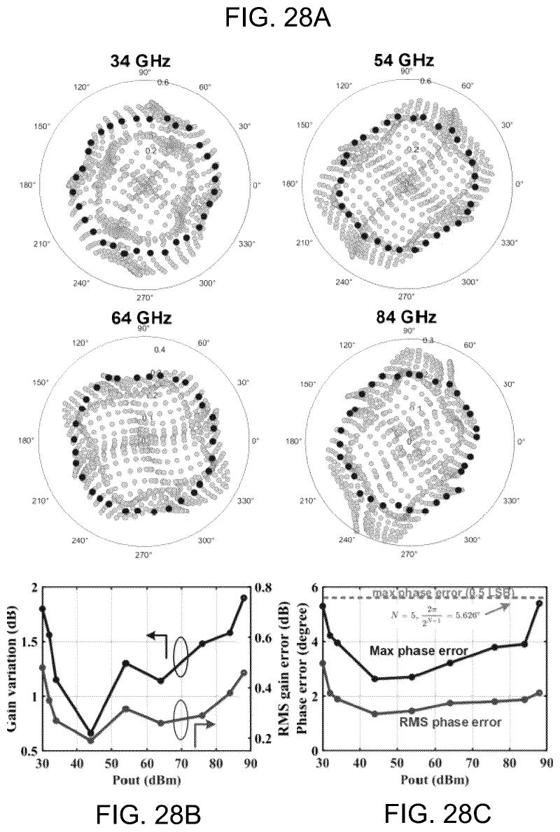

FIG. 28A graphically illustrates measured amplitude/phase at 34, 54, 64 and 84 GHz for the ultra-wideband phase shifter schematically depicted in FIG. 25A, FIG. 28B graphically illustrates measured gain variation and rms gain error vs. frequency for the ultra-wideband phase shifter schematically depicted in FIG. 25A, and FIG. 28C graphically illustrates measured max phase error and rms phase error vs. frequency for the ultra-wideband phase shifter schematically depicted in FIG. 25A. Specifically, FIG. 28A shows the measured amplitude/phase polar plot at 34, 54, 64 and 84 GHz. Across 30-88 GHZ, the gain variation across 32 codes is about 0.7-1.8 dB while the rms gain error is 0.19-0.48 dB (FIG. 28B). The very low rms phase error (FIG. 28C) of 1.34-3.1° and a maximum phase error of 2.63-5.4° are achieved across the 98.3% bandwidth. Maximum phase error lowering than half LSB) (5.625° demonstrates the 5-bit accuracy of this work.

2.2.4 Multi-Stage VGA with Tailored Peaking Frequency Response

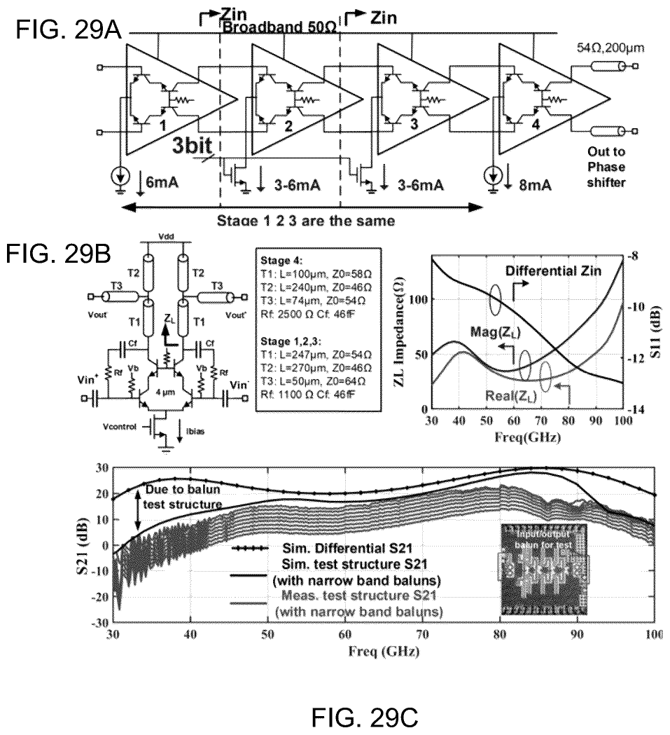

FIG. 29A schematically depicts a 4-stage differential cascode broadband VGA implemented with tail current control to allow 10 dB gain control range. FIG. 29B schematically depicts a T type network for peaking frequency response including a graphical illustration of this response. R-C feedback is added between the output and input for stability enhancement. To reduce the control-depended input/output impedance change, only middle stages (stage 2 and 3) are implemented with the 3-bit control. The first three stages are identical and interface with broadband 50Ω input impedance (Zin in FIG. 29B) under 50 12 differential load. To compensate for the dropping gain of the phase shifter at the higher end of the spectrum, the output network of each VGA stage is designed to have a peaking frequency response to allow a flat gain response of the chain. As shown in (FIG. 29B), the impedance (Z_{L}) looking into the transmission line based broadband T network demonstrates a higher value as frequency increases in both its magnitude and real part. FIG. 29C shows the simulated differential S₂₁ gain with gain peak of 30 dB at 85 GHz. The inventors created a VGA test structure (with an additional balun for broadband measurements). The measured S₂₁ plot shows acceptable correlation with simulation and is limited to narrower bandwidth due to the additional balun on both input and output that are not present in the Tx chain.

### 2.2.5 Active Balun

A balun is needed to convert the RF signal from power divider single-ended output (broadband 50Ω) to a differential signal feeding full differential phase shifter (100Ω differential input impedance). For conventional passive Marchand baluns, a large impedance transformation ratio such as 2 to 1 limits its bandwidth and introduce more passive loss at band edge. Therefore, this work adopts an active balun implementation for broadband and low loss.

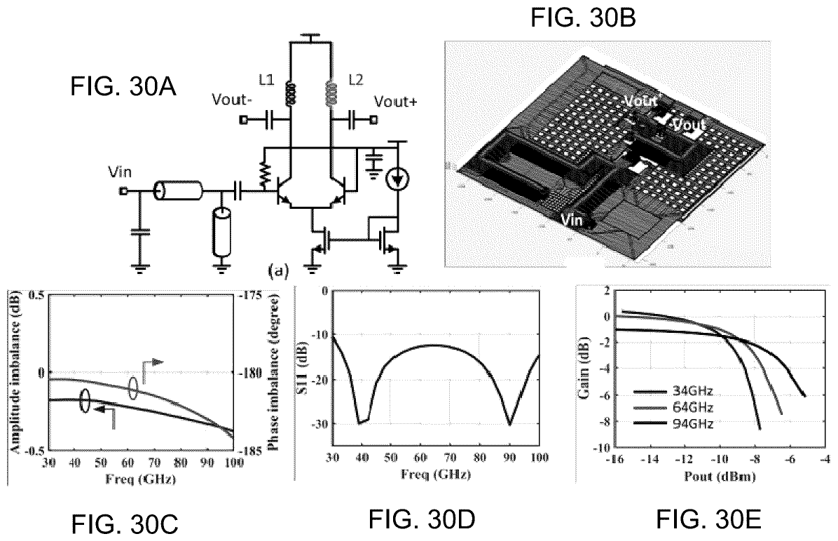

FIGS. 30A-30B schematically depict a RF active balun design and end to end layout of the active balun, respectfully. It is based on differential pair topology with one side AC ground. Due to the imperfection of the common mode rejection ratio of the differential pair at mmWave frequencies (e.g., the current source parasitic capacitance to ground), an asymmetrical inductive load is chosen here (L1≠L2) which can compensate the gain and phase mismatch between the two signal paths.

Attributed to the mismatch compensation techniques, the balun achieves a decent amplitude imbalance and phase imbalance of 0.1-0.4 dB and 0-4° across 30-100 GHz (FIG. 30C), with all three-port terminated as 50Ω (A 2:1 impedance transformation ratio). The input return loss is below −10 dB across 30-100 GHz (FIG. 30D) by implementing a dual-band input matching network. FIG. 30E shows the gain (the total output from differential output divided by input power) versus total output power at 34/64/94 GHz exhibiting gain of 0.2/0/−1 dB and OP1 dB of −10/−8/−7 dBm, respectively. Due to the high gain of the beamformer chain after the active balun, the active balun has enough output linearity range to drive the following stages. The active balun consumes 7 mA from a 2.5V supply.

2.2.6 Ultra-wideband Divider with Improved Isolation

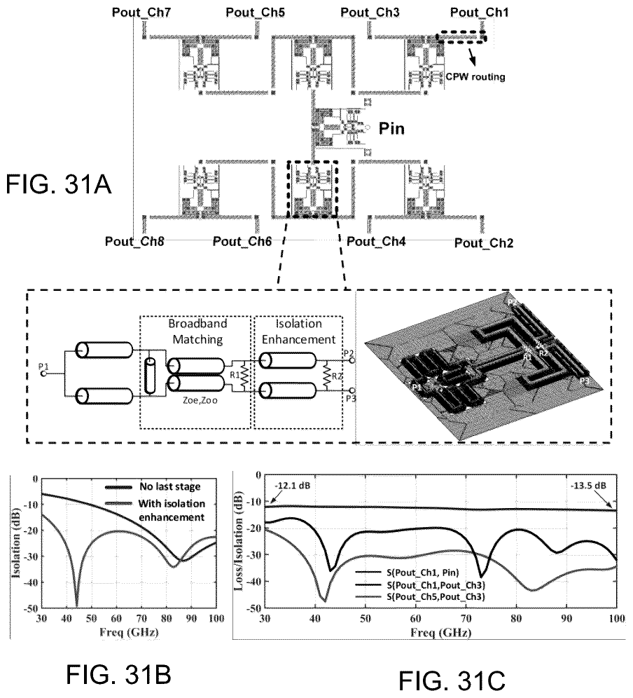

FIG. 31A schematically depicts a 1 to 8 ultra-wideband power dividing network with a 1 to 2 divider core implementation. The network is based on 50Ω 1 to 2 power divider cores with coplanar waveguide (CPW) broadband routing transmission lines. The ultra-wide bandwidth of the 1 to 2 divider core is enabled by a coupled line network following a traditional Wilkinson type divider. The odd and even mode resonances create a dual peak broadband loading response for the first dividing stage. For multichannel phased array, the isolation between each channel input is of great importance because a poor isolation leads to an interaction of phase tuning between channels, degrading the phase setting accuracy. Aₙ isolation enhancement technique by cascading another branch with a second isolation resistor significantly improves the isolation across band (FIG. 31B) while introduce only up to 0.2 dB insertion loss. As shown in FIG. 31C, the transducer gain from input to any of the output is from −12.1-13.5 dB, demonstrating an insertion loss of 4.5 dB at 100 GHz. The isolation between two adjacent ports originating from a same divider core (Pout_cn3 and Pout_cn1) is below-20 dB across 40-100 GHz (−20 to −15 dB across 30-40 GHz) while the isolation between two adjacent ports originating from a different divider core (Pout_cn3 and Pout_cn5) is below-30 dB across 37-100 GHz (−30 to −20 dB across 30-37 GHz).

### 2.2.7 Measurement Results

A fabricated beamformer transmitter was implemented in a 90 nm SiGe. As a key enabler, this 36-91 GHz ultra-broadband Tx beamformer maintains 1) maximum phase error below 0.5 LSB, r.m.s. phase error of 1.24-2.8°, r.m.s. gain error of 0.24-0.35 dB across the frequency range, 2) broadband PA with a deep-learning enabled matching network, and 3) broadband VGA with tailored frequency response across 87% bandwidth. The system operates with a 2V supply. The phase shifter and VGA consumes maximum power of 30 mW and 52 mW across code settings, respectively. The beamformer phase/amplitude response is measured using a 125 GHz Anritsu M4647B VNA. While the ultra-wideband quadrature generation network was designed to allow frequency-independent code setting for phase control, a frequency-dependent code optimization algorithm was employed that can correct the potential quadrature phase mismatch due to process variation and allowing a further performance improvement in terms of phase error and gain variation across frequency. With a one-time measurement across 30-100 GHz with a 10 GHz step, the process automates optimized code synthesis within the slotted 10 GHz bandwidths. In a measured linear phase response and amplitude plot across phase control code over 36-91 GHz, gain variation across phase control codes is about 1.1-1.6 dB while the r.m.s. gain error is 0.24-0.35 dB. The extremely low r.m.s. phase error of 1.24-2.8° and a maximum phase error of 2.4-5.6° are achieved across the 87% bandwidth. Maximum phase error smaller than half LSB) (5.625° demonstrates the effectiveness of the 5-bit phase control accuracy. The phase control code optimization can also be applied to compensate chip to chip variation. Due to process variation, by applying the same code to chip 2 as chip 1, the gain/phase error at the band edge of chip 2 degrades, but the accuracy can be recovered by applying new optimized code for chip 2. Measured S₂₁ of the Tx chain across the VGA 3-bit control settings is excellent. The phase control code applied is the one optimized for 60 GHz. The results demonstrate 30-35 dB gain across 36-90 GHz, broadband input return loss, and 10 dB of gain control as expected.

Measured large-signal performance (Pₒᵤₜ VS. Pᵢₙ) across 32 phase control codes exhibited a peak Psat of 15 dBm and OP_{1dB} of 13.5 dBm. At this OP_{1dB}, the total DC power consumption is 206 mW with a total Tx efficiency of 10.9%. The measured maximum OP_{1dB} is from 9 to 13.5 dBm across 36-90 GHz.

A custom setup for multi-Gb/s modulation measurements was created. A broadband mixer modulates the carrier frequency with high-speed data from the arbitrary waveform generator, and the output signal from the chip is down-converted by an external mixer and digitized by an 80-GS/s oscilloscope and analyzed by Keysight VSA software. The beamformer is measured with a 1.8 GHz bandwidth 64QAM signal (PAPR=9.65 dB). Without pre-distortion, the Tx chip demonstrates the EVM/ACLR of −25.6 dB/−31.9 dBc with average output power of 4 dBm at 10.8 Gbps at 60 GHz. The linear power corresponding to an EVM of −25 dBm are measured to be 4.1 dBm and 4.3 dBm for 10.8 Gbps and 9 Gbps data rates. Compared with the state-of-the-art mm Wave Tx phased array and broadband phase shifters (as noted in Table 3 below), the various embodiments demonstrate high gain, high data rate transmission and the best phase/amplitude errors over one of the widest bandwidths.

TABLE 3

| | | | | | | | BroadBand phase | |
|---|---|---|---|---|---|---|---|---|
| | | mmWave beamformer channel | | | | | shifters | |
| | This | Alhamed | Chen | Roy | Shahramian | Lee | Anjos | Pepe |
| | work | JSSC 22′ | TMTT 21′ | RFIC 19′ | TMTT 18′ | JSSC 19′ | TMTT 20′ | JSSC 17' |
| Technology | 90 nm | 90 nm | 28 nm | 28 nm | 180 nm | 130 nm | 250 nm | 28 nm |
| | SiGe | SiGe | CMOS | CMOS | SiGe | SiGe | BiCMOS | SOI |
| 0.5 LSB Error | 36-91 | — | — | — | — | | 14-50 | — |
| BW (GHz) * | (87%) | | | | | | (112.5%) | |
| S21 BW | 36-90 | 16-50 | 34-43 | 35-41 | 75-100 | 94GHz | 14-50 | 78-93 |
| (GHz) ** | (5 dB, 86%) | (5 dB, 97%) | (5 dB, 23%) | (5 dB, 16%) | (5 dB, 29%) | | (112.5%) | (16.3%) |
| Phase range | 360° | 360° | 360° | 360° | 360° | 360° | 180° | 360° |
| Phase | 5 | 5 | 4 | 5 | 4 | 8 | 2 | 4 |
| resolution | | | | | | | | |
| (bit) | | | | | | | | |
| Gain control | 10 | 16.2 | 20 | 10.2 | — | 10 | — | — |
| (dB) | | | | | | | | |
| Beamformer | 30-35 | 29.3-34.3 | 27.3-32.3 | 43-38 | 14-19 | 38.5 | −7.2 @ | 0.83 @ |
| gain (dB) | | | | | | | 32 GHz | 89 GHz |
| Max phase | 2.76-5.5 | — | — | — | 0.5-5 | 0.77 | 5.8-22.5 | — |
| error (°) | | | | | (82-105) | | | |
| RMS gain | 0.24-0.35 | <1.7 | 0.65-0.8 | — | 0.57 | 0.36 | <0.94 | 1.68-2 |
| error (dB) | | | (37-40 G) | | (90 G) | | | |
| RMS phase | 1.24-2.8 | <5.6 | 0.75-4.75 | — | 0.27 | 0.26 | <9.7 | 9.4-11.9 |
| error (°) | | | (37-40 G) | | (90 G) | | | |
| OP1 dB | 11-13.5 | 13.5-14.7 | 10.8 | 10.2-12.3 | 4.5-8.5 Psat | 3-4 | — | −5.2@ |
| (dBm) | (36-80 G) | (20-50 G) | (38 G) | (37-40 G) | (75-98) | (91-97) | | 89 GHz |
| P_{DC} (mW) | 214 @ | 250 @ | 187.5 | 339 @ | 500 (Tx + Rx) | 154 | 0 | 21.6 |
| | P1 dB | P1 dB | | P1 dB | | | | |
| | @60 GHz | | | | | | | |
| Modulation | 1 Gbps | 2.4 Gbps | 0.6 Gbps | 0.6 Gbps | 5MS/s | | — | — |
| | 64QAM | 64QAM | 64QAM | 64QAM | 256QAM | | | |
| EVM (dB)/ | −25 dB | −22 dB | −32 dB | −32 dB | 3% | | — | — |
| Pavg (dBm) | EVM | EVM @ | @−2 dBm | @−2 dBm | 0 dBm | | | |
| | @ | 6.8 dBm | @37 GHz | @37 GHz | 90 GHz | | | |
| | 4.8 dBm | @ | | | | | | |
| | @ | 44 GHz | | | | | | |
| | 54 GHz | | | | | | | |
| Chip area | 3 (with | 0.85(w/o | 2.2 (with | — | 0.5 (w/o | 1.7 (with | 0.48 (w/o | 0.12 (w/o |
| (mm²) | pad) | pad) | pad) | | pad) | pad) | pads) | pads) |

### 2.3 Broadband IQ Direct Up-Converter Design

### 2.3.1 IQ Mixer

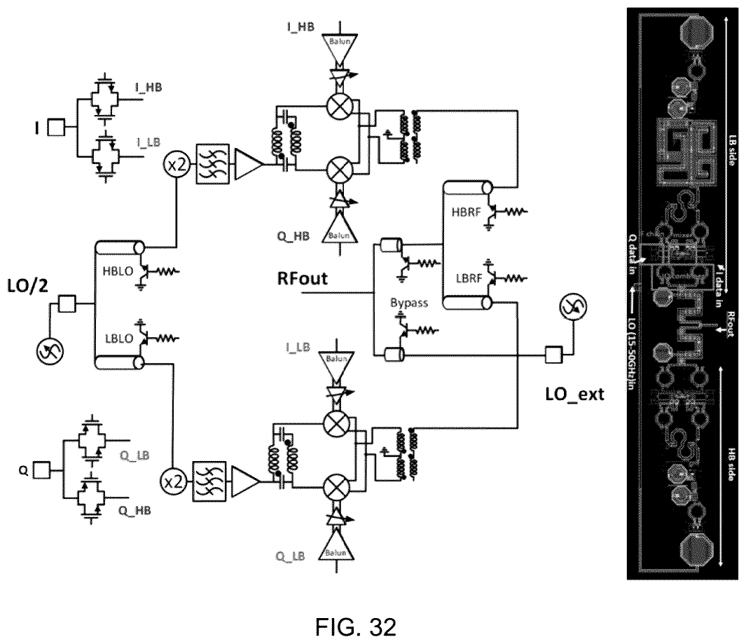

FIG. 32 depicts an exemplary IQ direct up-convert transmitter architecture according to an embodiment. The architecture consists of two upconverters which cover LB (30-55 GHz) and HB (55-100 GHz), respectively. A band select switch (similar design principle as shown in section 2.2) is used to alternate between the LB and HB upconverter RF outputs. The 2 bands reconfigurable structure is necessitated: The LO generation chain requires a frequency multiplier to lower the frequency of the external LO input and thus the loss of PCB LO routing. If using a full broadband (approximately 24-100 GHZ, 30-100 GHz, etc.) LO generation chain, the unwanted harmonics from the frequency multiplier will lie in band due to the more than octave bandwidth of the system. For instance, a frequency doubler that generates a 40 GHz LO signal will simultaneously produce an unwanted 80 GHz 4th harmonic, while a frequency quadrupler generating 80 GHz would yield an undesired 2nd harmonic, which necessitates the filtering of these undesirable harmonics before they enter the mixer to avoid the mixing spurs. The challenge here is that the change of carrier frequency requires the use of a frequency reconfigurable filter, a multi-bit switchable filter that proves exceedingly difficult to implement at mm Wave frequency, particularly in the LO chain, where a large voltage swing leads to nonlinearity issues. Consequently, a two-band separation architecture was implemented that features a fixed filter in each of the chains, where both chains (with a frequency doubler) cover a carrier frequency range that is less than 2:1. As a result, an inband band-pass filter enables the complete removal of unwanted harmonics.

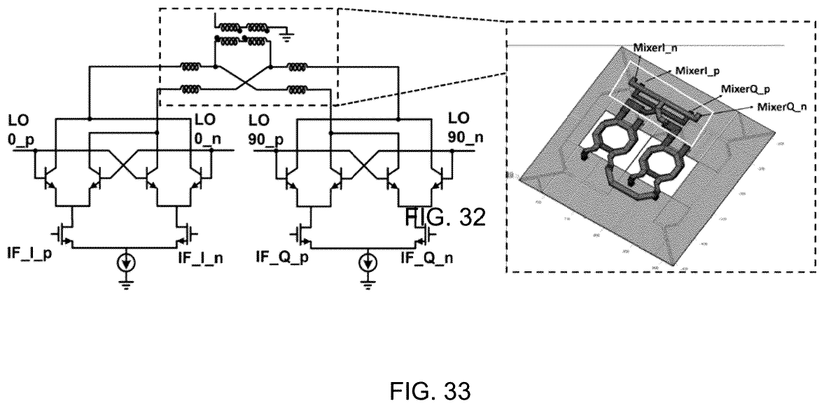

FIG. 33 depicts an IQ mixer schematic and Marchand balun combining network. As shown in FIG. 33, each mixer follows a Gilbert cell based double balanced topology with a bias tail current. Because the IF inputs are resistive biased with the previous stage (IF VGA), the tail current is needed to reduce the sensitivity of the input transistor's transconductance to the common mode voltage changes. The output current combining with a broadband Marchand balun for single-ended output is illustrated. The balanced mixer topology aims to improve the LO leakage due to the ideal balanced coupling path from LO+ and LO− to the RF port. The mixer layout at high frequency has critical impact on the LO leakage performance.

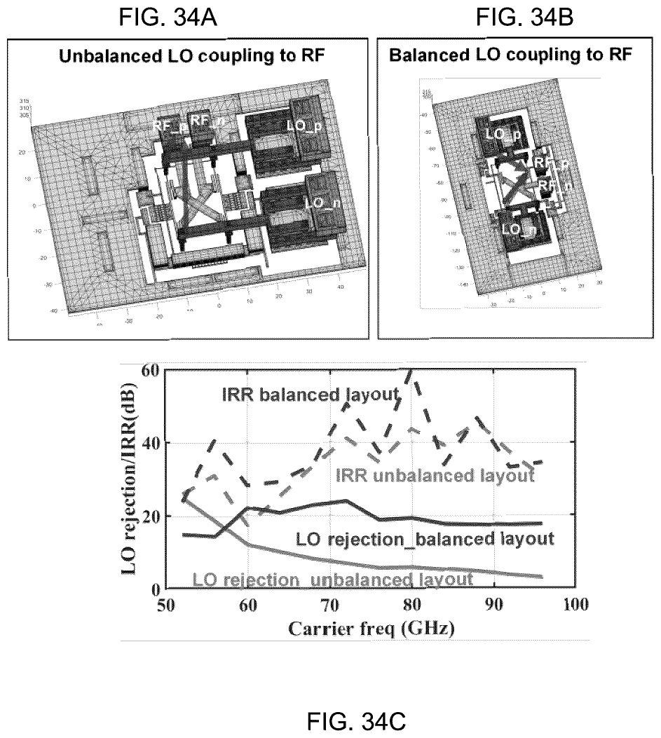

FIG. 34A-34B depict an active mixer IQ core design with balanced and unbalanced layouts, respectively. FIG. 34C graphically illustrates a comparison of IRR and LO rejection for the active IQ mixer core design with balanced and unbalanced layouts as respectively depicted in FIGS. 34A-34B. Referring to FIG. 34B, a balanced layout enables a roughly equal physical path between differential LO port to output node, compared to the unbalanced LO-RF allocation in FIG. 34A, it improves the LO rejection significantly (>15 dB) at 60-90 GHz frequency while maintaining the same image rejection ratio (a parameter defined to evaluate the IQ mismatch of the transmitter) as seen in FIG. 34C.

### 2.3.2 IF Active Balun and IF VGA

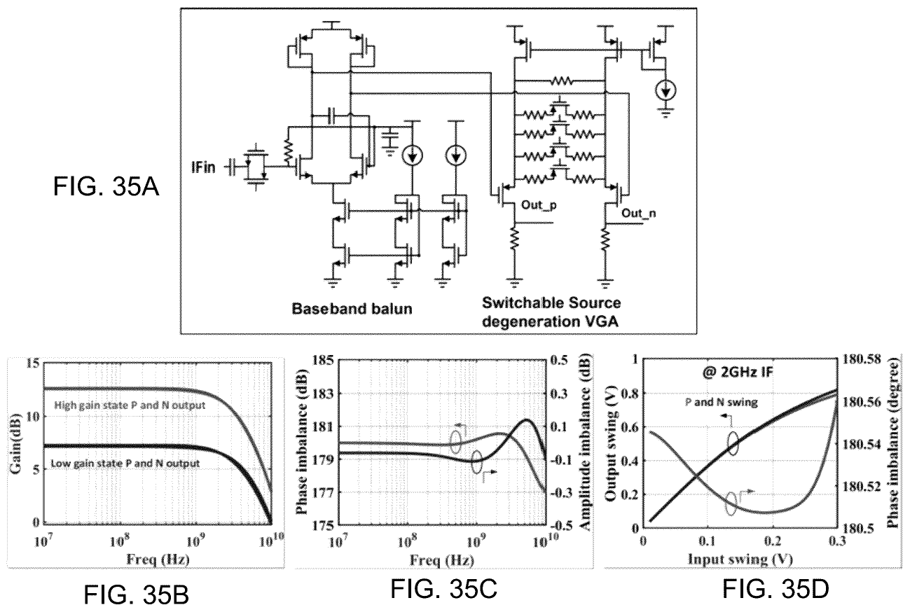

FIG. 35A schematically depicts a baseband balun and IF VGA. FIGS. 35B, 35C, and 35D graphically illustrate frequency response of the IF chain for different gain state, phase and amplitude imbalance frequency response, and performance versus input swing, respectively of the baseband balun and IF VGA of FIG. 35A.

Specifically, FIG. 35A is a schematic of the IF chain where a differential VGA precedes a baseband active balun. The baseband balun substantially reduces the complexity of differential 1 to 15 baseband routing on PCB. It follows the similar principle as the RF active balun where a neutralization cap is added to compensate the influence of the finite impedance looking into the current source on the balancing performance. A cascode current source is used to further boost the low frequency resistance for higher common mode rejection ratio. The diode connected load is used to bias the VGA stage for smaller process variation compared to resistors. The VGA adopts switchable source degeneration resistor for different 4-bit gain control. This mitigates the gain code dependent phase change of the VGA. The IF chain demonstrates a 4 GHz 3 dB bandwidth with 6 dB gain control range from 7-13 dB (FIG. 35B). From DC to 4 GHZ, the phase mismatch is below 0.50 while amplitude imbalance is below 0.1 dB (FIG. 35C). At 2 GHz IF frequency, FIG. 35D shows the voltage swing for each output as a function of input swing. The input 1 dB compression swing is about 250 mV which is high enough for real application and both phase and amplitude balancing performance is still maintained under large swing.

### 2.3.3 LO Chain

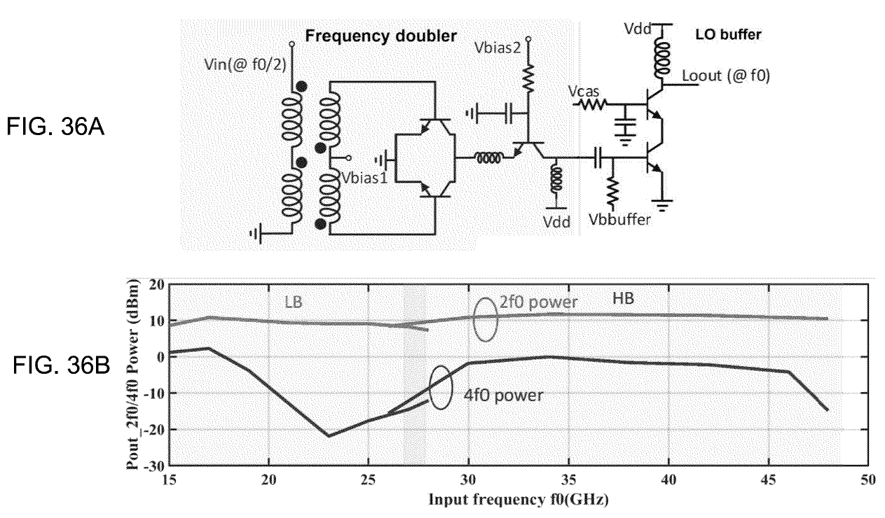

FIG. 36A schematically depicts a frequency doubler and LO buffer, and FIG. 36B graphically illustrates simulated output LO power and 4th harmonic across frequency. In the schematic of the LO chain shown in FIG. 36A it can be seen that an input balun feeds the differential input of a stacked push-push doubler where the bottom stage is biased at deep class AB mode for better second harmonic generation. The common mode second harmonic signal then passes through the top common base like transistor for a stacked higher gain. The doubler is followed by a cascode LO buffer for further boost of LO chain gain and LO swing. The output of the LO buffer is connected to the harmonic filter, followed by a quadrature hybrid, whose design is detailed in section 2.2.3, to deliver the LO signal for I and Q mixers. The simulated output 2nd harmonic and undesirable 4th harmonic power is plotted from 15-46 GHz fundamental input frequency range (FIG. 36B). A constant larger than 10 dBm output power enables the high conversion gain of the mixer and over all >10 dB 4th harmonic rejection further alleviates the rejection requirement of the harmonic filter design.

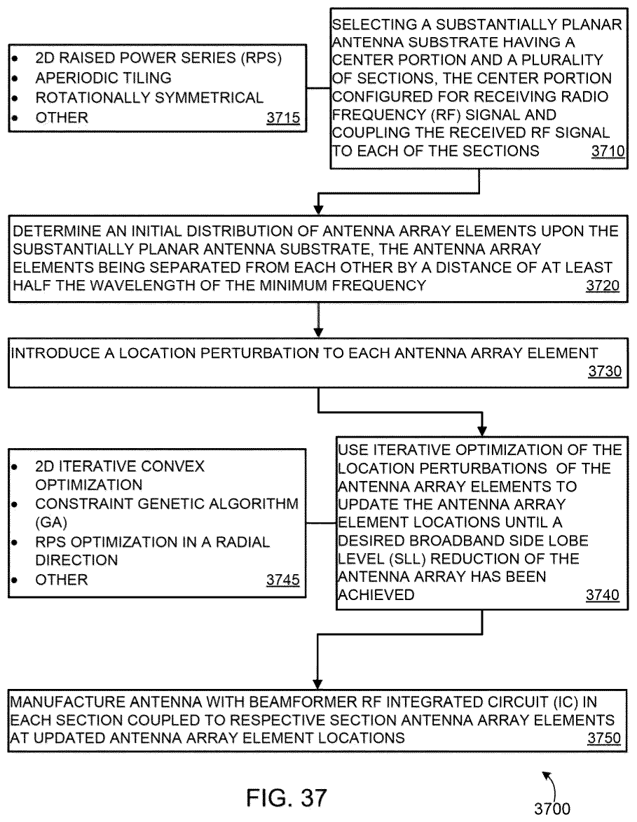

FIG. 37 depicts a method according to an embodiment. Specifically, FIG. 37 depicts a method of optimizing and manufacturing a planar antenna. The method 3700 of FIG. 37 may be adapted in accordance with disclosure provided above with respect to the various embodiments and relevant figures.

Generally speaking, the method 3700 of FIG. 37 contemplates first optimizing a non-uniform sparse antenna array configured to operate at a minimum frequency, wherein a substantially planar antenna substrate having a center portion and a plurality of sections has been selected. The center portion being configured for receiving radio frequency (RF) signal and coupling the received RF signal to each of the sections, each of the sections having disposed thereat a respective beamformer RF integrated circuit (IC) and a respective plurality of broadband dual port antennas, the beamformer RFIC configured to process RF signal received from the center portion to provide a respective processed RF output signal to each of the broadband dual port antennas, the each of the broadband dual port antennas on the substantially planar antenna substrate comprising an antenna array element having associated with it a respective location.

At step 3710, a substantially planar antenna substrate having a center portion and a plurality of sections is selected, the center portion being configured for receiving radio frequency (RF) signal and coupling the received RF signal to each of the sections. Referring to box 3715, the antenna array be configured in accordance with a 2D raised power series, aperiodic tiling, rotational symmetry (e.g., “pizza slice”), or some other type of array or configuration thereof, such as described in more detail above.

At step 3720, a determination is made as to an initial distribution of antenna array elements upon the substantially planar antenna substrate, the antenna array elements being separated from each other by a distance of at least half the wavelength of the minimum frequency.

At step 3730, a location perturbation δₙ is introduced to each antenna array element as discussed above;

At step 3740, iterative optimization of the location perturbations δₙ of the antenna array elements is used to update the corresponding antenna array element locations until a desired broadband side lobe level (SLL) reduction of the antenna array has been achieved. Referring to box 3745, the iterative optimization may comprise 2D convex optimization, constraint genetic algorithm, raised power series in a radial direction optimization, and/or other forms of optimization.

At step 3780, the optimized antenna array design is manufactured.

### 2.3.4 CW and Dynamic Modulation Performance

Simulated CW performance of the up-converter shows that across a 30-96 GHz carrier frequency, the up-converter achieves −1.8 to 2.5 dBm OP1 dB. With a small signal IF input, 14.5 to 18 dB conversion gain, 18-35 dB LO rejection ratio and beyond 20 dB image rejection ratio are reached. At 96 GHz, the performance as an input IF power is 0.2 dBm OP1 dB at a chip input and a realized swing of 80 mV.

The upconverter was also tested with 4 Gbps 16QAM I and Q baseband pulse (with pulse shaping coefficient α=0.35) with an external LO frequency of 48 GHz (carrier frequency of 96 GHz). 1000 random symbols were tested and the output signal de-modulated to present its constellation. A good EVM of −30.1 dB at −2 dBm Pout demonstrates the integrity and low signal distortion of the transmitter.

As discussed above, various embodiments are configured to use overlap patch antenna elements as the array antennas since these antennas are easy to fabricate, have a small footprint, and maintains a stable antenna pattern with good beamwidth across multiple bands over an octave frequency range (from 37-100 GHz covering 5G band, V band, E band/new licensed 5G band, and W band). The performance of such an antenna element is summarized below with respect to the various figures.

Current industry phased array solutions are bandwidth limited and its throughput and functionality can be significantly enhanced using the disclosed broadband/multi-band architecture. A fully integrated solution connecting the disclosed antenna array to an integrated front-end circuit will greatly enhance the data rate and enrich the functionality of future wireless user equipment (e.g., mobile phone and other devices).

For example, as shown and described with respect to FIGS. 2 and 3A, the design procedure starts from an unconventional 2D element initial conditions/coordinate distribution, and then one applies the corresponding optimization method to achieve low side lobe level across wide beam steering angles across ultra-broadband frequency range. Based on the mathematical optimization result, the next procedure will replace each element with a real multi-band or UWB antenna design to form the final array layout. The full array is a hardware implemented using multi-layer antenna in package (AiP) technology.

The disclosed approach is self-sustained. While the non-uniform and randomness of element distribution may make the feeding network harder, this can be solved by a customized IC and pad routing design to make sure all the feed lines are in-phase between each other.

A full wave 3D simulation has been done to successfully verify the disclosed approach. The HFSS full wave simulation is a commercial electromagnetic calculation software which can predict the real-world experiment extremely well. A full 3D array implementation with overlap patch antenna element design was simulated and analyzed and the results are summarized in, illustratively, FIGS. 16A-16C, thus demonstrating an expected wide angle beam steering performance with decent side lobe level, realized again across larger than an octave multifrequency range. (37 GHz, 55 GHz, 75 GHz, 90 GHz, 100 GHz). Due to the low side lobe level control, the system can also demonstrate a multi-beam pattern (2 beams as an example) across a wide frequency range by proper amplitude and phase control.

Various embodiments provide dynamically programmable, frequency agile operation with high spectral efficiency, while simultaneously targeting 5G, V band, E band/new unlicensed 5G and W band as the proof of concept. Combination of the proposed architectures with the current existing MIMO approaches, such multi-band phased array system can potentially form the backbone of the next generation of wireless networks utilizing multiple available spaced spectra.

The disclosed approach has applicability, inter alia, to the transceiver RF frontend systems which will be the foundation of mmWave 5G/6G wireless communication systems and multi-functional sensing platforms.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. Aₙ antenna array configured to operate at a minimum frequency, comprising:
a substantially planar substrate having non-uniformly distributed thereupon at respective locations a plurality of broadband antennas to form thereby a two-dimensional (2D) array of non-uniformly spaced antenna array elements;
wherein the substrate location of each antenna array element is separated from the substrate location of each adjacent antenna array element by a respective distance of at least half the wavelength of the minimum frequency, the locations of the antenna array elements on the substrate being selected in accordance with a desired reduction in a broadband side lobe level (SLL) of a radio frequency (RF) transmission signal.

2. The antenna array of claim 1, wherein antenna array element locations are selected by:
determining an initial distribution of antenna array elements upon the substantially planar antenna substrate, the antenna array elements being separated from each other by a distance of at least half the wavelength of the minimum frequency;
introducing a location perturbation δₙ to each antenna array element; and
using iterative optimization of the location perturbations δₙ of the antenna array elements to update the antenna array element locations until the desired broadband SLL reduction across a plurality of 2D beam steering angles of the antenna array has been achieved.

3. The antenna array of claim 2, wherein the location perturbation δₙ of an array element conforms to the following limit:
$$\vert \frac{2 π F}{C} \times {δ}_{n} \vert ≪ 1 ,$$
where 2πf/C is the free space wave number, C is the light speed.

4. The antenna array of claim 2, wherein the antenna array comprises a substantially circular array having a plurality of sections, each section having the same number of antenna array elements, wherein the location perturbations δₙ are optimized to cause the antenna array element locations in each section to be substantially the same.

5. The antenna array of claim 2, wherein the antenna array comprises a 2D raised power series (RPS) array, and the location perturbations δₙ are optimized using 2D iterative convex optimization.

6. The antenna array of claim 2, wherein the antenna array comprises an aperiodic tiling array, and the location perturbations δₙ are optimized using a constraint genetic algorithm (GA).

7. The antenna array of claim 2, wherein the antenna array comprises a multiturn circular array, and the location perturbations δₙ are optimized by applying RPS optimization in a radial direction.

8. The antenna array of claim 2, wherein the antenna array comprises a rotationally symmetrical array comprising a plurality of slices, and the location perturbations δₙ are optimized in each slice using a constraint genetic algorithm (GA).

9. The antenna array of claim 2, wherein the antennas comprise overlap patch antenna elements.

10. The antenna array of claim 9, wherein the antennas are configured to operate in a frequency range of approximately 24-100 GHz.

11. The antenna array of claim 2, wherein each antenna comprises a spiral antenna.

12. The antenna array of claim 2, wherein each antenna comprises a bowtie antenna.

13. The antenna array of claim 2, wherein each antenna is configured to selectively operate in a low band (LB) spectral region or a high band (HB) spectral region.

14. The antenna array of claim 2, wherein the antenna array comprises a plurality of sections, each section having a respective plurality of antenna array elements, wherein the location perturbations δₙ are optimized to cause the antenna array element locations in each section to be substantially the same.

15. The antenna array of claim 14, wherein each section comprises a respective portion of the antenna substrate between a center portion of the antenna substrate and an outer edge of the antenna substrate.

16. The antenna array of claim 14, wherein the antenna substrate has a substantially circular shape divided into an odd number of sections.

17. A method of optimizing an antenna array configured to operate at a minimum frequency, comprising:
determining an initial distribution of antenna array elements upon a substantially planar antenna substrate, the antenna array elements being separated from each other by a distance of at least half the wavelength of the minimum frequency;
introducing a location perturbation δₙ to each antenna array element; and
using iterative optimization of the location perturbations δₙ of the antenna array elements to update the antenna array element locations until a desired broadband side lobe level (SLL) reduction across a plurality of 2D beam steering angles of the antenna array has been achieved.

18. The method of claim 17, wherein the location perturbation δₙ of an array element conforms to the following limit:
$$\vert \frac{2 π F}{C} \times {δ}_{n} \vert ≪ 1 ,$$
where 2πf/C is the free space wave number, C is the light speed.

19. The method of claim 17, wherein the antenna array comprises a plurality of sections, each section having a respective plurality of antenna array elements, wherein the location perturbations δₙ are optimized to cause the antenna array element locations in each section to be substantially the same.

20. The method of claim 19, wherein the antenna array comprises a substantially circular array with each section having the same number of antenna array elements.

21. The method of claim 17, wherein the antenna array comprises a 2D raised power series (RPS) array, and the location perturbations δₙ are optimized using 2D iterative convex optimization.

22. The method of claim 17, wherein the antenna array comprises an aperiodic tiling array, and the location perturbations δₙ are optimized using a constraint genetic algorithm (GA).

23. The method of claim 17, wherein the antenna array comprises a multiturn circular array, and the location perturbations δₙ are optimized by applying RPS optimization in a radial direction.

24. The method of claim 19, wherein the antenna array comprises a rotationally symmetrical array comprising a plurality of slices, and the location perturbations δₙ are optimized in each slice using a constraint genetic algorithm (GA).

25. Aₙ antenna system configured to operate at a minimum frequency, comprising:
a substantially planar substrate having non-uniformly distributed thereupon at respective locations a plurality of broadband antennas to form thereby a two-dimensional (2D) array of non-uniformly spaced antenna array elements;
wherein the substrate location of each antenna array element is separated from the substrate location of each adjacent antenna array element by a respective distance of at least half the wavelength of the minimum frequency, the locations of the antenna array elements on the substrate being selected in accordance with a desired reduction in a broadband side lobe level (SLL) of a radio frequency (RF) transmission signal.

26. The antenna system of claim 25, further comprising:
the substantially planar antenna substrate having a center portion and a plurality of sections;
the center portion configured for receiving radio frequency (RF) signal and coupling the received RF signal to each of the sections;
each of the sections having disposed thereat a respective beamformer RF integrated circuit (IC) and a respective plurality of the broadband antennas, the beamformer RFIC configured to process RF signal received from the center portion to provide a respective processed RF output signal to each of the broadband antennas;
wherein the antenna array element locations are selected by:
determining an initial distribution of antenna array elements upon the substantially planar antenna substrate, the antenna array elements being separated from each other by a distance of at least half the wavelength of the minimum frequency;
introducing a location perturbation δₙ to each antenna array element; and
using iterative optimization of the location perturbations on of the antenna array elements to update the antenna array element locations until a desired broadband side lobe level (SLL) reduction of the antenna array has been achieved.
